(19) United States
(12) Patent Application Publication
(10) Pub. No.: US 2012/0271677 A1
(43) Pub. Date: Oct. 25, 2012

(54) Tracking, Accounting, and Reporting Machine

(76) Inventor: James S. Rhodes, III, La Jolla, CA (US)

(21) Appl. No.: 13/454,004

(22) Filed: Apr. 23, 2012

Related U.S. Application Data
(63) Continuation-in-part of application No. 13/192,173, filed on Jul. 27, 2011.
(60) Provisional application No. 61/592,334, filed on Jan. 30, 2012.
(60) Provisional application No. 61/608,614, filed on Mar. 8, 2012.
(60) Provisional application No. 61/477,860, filed on Apr. 21, 2011.

(51) Int. Cl. G06Q 10/06; G06Q 40/00

(52) U.S. Cl. 705/7.27; 705/35

(57) ABSTRACT

Feedstock of an agricultural biomass is tracked through a first supply chain. Residue of the agricultural biomass is tracked through a second supply chain. A quantity of fuel, produced from the feedstock, having a carbon intensity value is determined based on utilization of the residue in the second supply chain.

### CROSS REFERENCE TO RELATED APPLICATIONS

This application claims the benefit of and priority to U.S. provisional patent application No. 61/592,334 filed Jan. 30, 2012, and U.S. provisional patent application No. 61/608,614 filed Mar. 8, 2012. In addition, this application is a continuation in part of U.S. patent application Ser. No. 13/192,173 filed Jul. 27, 2011, which claims the benefit of and priority to U.S. provisional patent application No. 61/477,860 filed on Apr. 21, 2011. The entire disclosure of each application is herein incorporated by reference.

### FIELD OF THE TECHNOLOGY

The invention relates generally to fuel production, including biofuels and hydrocarbon fuels, and related products. The invention relates more particularly to methods of accounting for carbon, material, product, and co-product flows, determining a regulatory value for the fuel or related product of interest, and compiling appropriate documentation evidencing the regulatory determination, methods of engineering carbon cycles for low emission fuel production systems, and methods of manufacturing fuels and/or related products, as well as the fuels and regulatory values derived therefrom.

### BACKGROUND

Carbon intensity (CI) is a fuel characteristic that is increasingly being measured and regulated in various jurisdictions within the U.S. and abroad (e.g., U.S. RFS2; LCFS in CA, BC, WA, OR, NEMA; EU-RED; UK-RTFO). CI can be used as a measure of net greenhouse gas emissions from across the fuel life cycle generally evaluated using lifecycle analysis (LCA) methods and specified per unit fuel energy, e.g., in units of gram CO₂ equivalent emissions per mega-joule of fuel (gCO₂e/MJ). For biofuels, for example, carbon intensity measures can include emissions from sources associated with supplying inputs for agricultural production (e.g., fertilizers), fuel combustion, and certain or all process steps in between, which can be used to define a fuel production pathway, or simply a fuel pathway. LCA of carbon intensity can be set up as an accounting system with emissions to the atmosphere (e.g., combustion emissions) representing emissions accounting debits and flows from the atmosphere (e.g., carbon fixed from the atmosphere via photosynthesis or CO₂ directly captured from the atmosphere via industrial processes) representing emissions accounting credits. The sign convention may be reversed relative to financial accounting.

### SUMMARY OF THE INVENTION

The invention features, in various embodiments, tracking, accounting, and reporting machines and methods (“TARM”), which can provide, in the case of Whole Crop Biofuel Production (“WCBP”), parallel tracking of biofuel feedstock and associated residues through their respective supply chains, the computation of resulting fuel CI values that reflect actual residue utilization rather than simplified assumptions, consolidated reporting of resulting CI values, and/or compilation of documentation evidencing CI computation and assignment. In other words TARM methods can compute the CI (carbon intensity) for a given quantity of biofuel based on both the biofuel-feedstock supply chain and the agricultural residues supply chain. In the case of algae, algal biofuels and/or related products, the TARM can provide tracking of CO₂ and/or other inputs across potentially multiple sources, the computation of resulting CI values that reflect actual supply chains (including potential co-products) rather than simplified assumptions, consolidated reporting of resulting CI values, and/or compilation of documentation evidencing CI computation and assignment. In the case of hydrocarbons, hydrocarbon fuels, and/or related products, the TARM can provide tracking of CO₂ and/or other inputs across potentially multiple sources, the computation of resulting CI values that reflect actual supply chains (including potential co-products, CO₂ sequestration in geologic formations, and/or potential leakage rates) rather than simplified assumptions, consolidated reporting of resulting CI values, and/or compilation of documentation evidencing CI computation and assignment.

LCA methods can be used to assess a variety of social and environmental performance characteristics of biofuels, which can collectively be referred to using the term sustainability. Fuel sustainability characteristics or sustainability performance can be reflected within fuel, energy, and related policy instruments (e.g., as a quantitative value associated with, or characterizing, the fuel, as well as related standards), to provide a framework for avoiding potential negative consequences of fuel production and use.

The effects of using carbon captured from the atmosphere (e.g., via photosynthesis or industrial systems) and of producing co-products in fuel production can be reflected in evaluations of fuel performance against carbon intensity measures and/or other sustainability metrics. In other words, LCA can reflect emissions credits and debits accrued across the whole fuel production pathway or supply chain, including emissions effects of biomass carbon not converted into biofuels, atmospheric carbon captured in the fuel supply chain, co-products of fuel production, and carbon sequestered away from the atmosphere (e.g., in geologic formations). This can be accomplished by providing a lifecycle emissions (or sustainability) accounting credit to the product of interest (e.g., biofuel, hydrocarbon fuel, or related product of interest). This credit can be defined in a variety of ways, including for example: providing credits by allocating a fraction of lifecycle emissions (generally emissions associated with processes upstream of the material diversion for co-product use) to the various products/co-products (according to so called “allocation” accounting methodologies); and/or by providing lifecycle emissions accounting credits (or debits) for net emissions reductions (or increases) associated with use of the various co-products/by-products relative to use of more conventional products (according to so called “system expansion” accounting methodology); and/or providing lifecycle accounting credits for atmospheric carbon captured within the supply chain (e.g., via photosynthesis or industrial systems); and/or providing lifecycle accounting credits for carbon sequestered away from the atmosphere (e.g., in geologic formations).

The invention can be applied to so called “first generation biofuels,” which dominate the portfolio of currently available biofuels. These biofuels are generally produced from starch, sugar, or lipid-rich portions of plants, such as oil seeds (e.g., canola), legumes (e.g., soybeans), cereal grains (e.g., corn or wheat), sugar cane, and other similar plant matter (e.g., sorghum, sugar beet, and the like). Strategies for reducing the carbon intensity and improving the sustainability performance of such biofuels, including efforts to reduce agricultural inputs to production, use low carbon resources to supply energy required to convert biomass feedstock into biofuel, employ supply chain optimization to reduce emissions from feedstock and product transport, and integrate multiple co-products in converting biomass feedstock to biofuels would be advantageous.

Because first generation biofuel production systems are only capable of converting starch, sugar, or lipid rich portions of crop biomass (e.g., corn kernels, soybeans, canola seeds, etc.) into biofuels, they inherently involve production of substantial quantities of agricultural residues (e.g., stalks, stems, leaves, corn cobs, husks, shells, etc.). Agricultural residues can be a potential energy, chemical, and carbon resource. While substantial quantities of these resources are produced within first generation biofuel supply chains, strategies to reduce the carbon intensity of first generation biofuels do not include utilization of these agricultural residues (e.g., by mitigating anthropogenic greenhouse gas emissions and coupling the mitigation to a biofuel, thereby producing a biofuel having a more favorable regulatory value). Instead, these agricultural residues are typically included in LCA measures of biofuel carbon intensity with the assumption that their carbon is emitted back to the atmosphere in the form of CO₂ (balancing a portion of atmospheric carbon fixed via photosynthesis during crop production). As such, the carbon value—as well as potential energy or chemical values—of these resources is not realized in first generation biofuel production systems or associated LCAs.

Certain first generation-type biofuel production processes can be combined with agricultural residue use, for example, to supply energy to the feedstock to biofuel conversion process. For example, a first generation-type biofuel production process can use biomass (alone or in combinations with other energy sources) to supply heat and/or power for biofuel production. However, agricultural residue from biofuel feedstock production is not generally used for such purposes because the opportunities for such integration would be necessarily limited by quantities and feedstock characteristics of the agricultural residues, the operational requirements of the conversion system, and by requirements to transport both the biofuel feedstock and the agricultural residue to the biofuel production facility, which can be compromised by characteristics of the agricultural residues (e.g., low bulk and energy densities). Rather, alternate biomass resources can be applied for this purpose with potentially simpler logistics requirements and superior technical performance (e.g., burning woody biomass or agricultural residues supplied from locations closer to the biofuel plant). In contract, the invention provides methods for mitigating anthropogenic greenhouse gas emissions and coupling the mitigation to a biofuel, thereby producing a biofuel having a more favorable regulatory value than first generation-type biofuels.

Numerous technologies exist independently, and more are being researched and developed, for using agricultural residues to produce energy products, chemicals, plastics, soil amendments, and/or to sequester biomass carbon away from the atmosphere for timescales relevant for advancing climate policy objectives. Such technologies have the potential to enable agricultural residues to displace conventional fossil hydrocarbon products (e.g., produced using fossil fuels or fossil hydrocarbon feedstock), generate emissions offsets, or otherwise generate emissions credits or other sustainability benefits within lifecycle accounting frameworks and/or within certain regulatory frameworks. The invention provides for the integration of systems capable of utilizing agricultural residues resulting as a consequence of first generation biofuel feedstock production, thereby enabling the production of biofuels with substantially lower carbon intensities due to the effective utilization of the whole crop. This integration is a feature of the invention, which is termed here as Whole Crop Biofuel Production (“WCBP”).

Agricultural residues have been separately evaluated, along with dedicated energy crops (e.g., switchgrass, miscanthus, poplar, and the like), as a feedstock for so called cellulosic (AKA second generation or ligno-cellulosic) biofuel production. LCA carbon intensity measures for cellulosic biofuels benefit from several characteristics of their production systems. One benefit, which contrasts with existing first generation biofuel production systems, is that the production process involves processing the feedstock biomass in its entirety—there is effectively no agricultural residue (or agricultural residues from other production systems are used as feedstock for biofuel production). This is a substantial benefit because it enables all of the photosynthetic activity associated with feedstock production to be leveraged in the biofuel production system, as opposed to only the portion associated with sugar, starch, or lipid rich biomass used in first generation biofuel production systems.

While cellulosic production systems can process the whole biomass, only a certain fractions of it (e.g., the cellulosic and hemi-cellulosic fractions in fermentation based systems) can be converted to biofuel. The balance (e.g., composed of lignin biomass fractions and residues from fermentation) can be burned to provide process heat and power. Such heat and power can exceed facility process requirements and the excess can be exported to the local power grid. LCA measures of carbon intensity therefore can include an LCA emissions accounting credit (e.g., carbon credit) for electricity exports as a co-product of biofuel production (e.g., cellulosic biofuel production). WCBP also provides for the analogous utilization of biomass fractions not suitable for conversion to biofuel produced in first generation production systems (e.g., agricultural residues) within the context of LCAs and/or carbon intensity measures.

For the purpose of measuring lifecycle carbon intensity there is generally no difference between co-products produced in the biofuel conversion process (e.g., electricity exports from lignin combustion in cellulosic biofuel conversion processes) and those produced at other points in the supply chain (e.g., electricity exports from combustion of agricultural residues produced as a consequence of first generation biofuel feedstock production). Similar LCA emissions accounting credits can be assigned to both. (e.g., accounting credits should be equal on a per kilowatt hour basis, but should also reflect relative quantities of electricity produced per unit of biofuel and potentially different greenhouse gas emissions associated with electricity displaced in different locations.) As a practical matter, however, production of such co-products can involve different processes, technologies, supply chains, and management systems.

The potential for utilization of agricultural residues produced as a consequence of first generation biofuel feedstock production to provide LCA emissions accounting credits in biofuel carbon intensity calculations and improve biofuel sustainability performance has not previously been recognized. As such, production systems that leverage this potential to maximize the value of the whole crop in biofuel production—including fuel, co-product, carbon, and sustainability performance—have not been disclosed, proposed, or developed. In various aspects and embodiments, the invention includes such production systems and methods, as well as the resulting biofuels (and co-products) having reduced carbon intensity and improved sustainability performance.

Many current biofuel production technologies can be implemented with utilization of associated agricultural residues to reduce the greenhouse gas intensity (“carbon intensity”), or greenhouse gas emissions per unit of fuel energy produced, often measured in units of grams carbon dioxide equivalent emissions per mega-joule (gCO₂e/MJ), and/or to improve the broader environmental performance or sustainability of biofuel production (cite WCBP and SPBCS applications). In such production systems, the carbon intensity and environmental performance can depends on: (i) the processes used and impacts from biofuels production and utilization; and ii) the processes used and impacts from the utilization of agricultural residues. These impacts can be evaluated in theoretical terms via established methodologies associated with lifecycle analysis (LCA). Realizing the full value of these production systems in practice, however, can require a method for determining the carbon intensity and/or environmental performance of each unit of biofuel. This requires a system for tracking the utilization of agricultural residues associated with each unit of biofuel produced, accounting for the resulting carbon intensity and/environmental performance, and generating reports to document and substantiate the results.

This process can be complicated by several factors. First, a particular quantity of biofuels can be produced from feedstock (e.g., corn kernels, sugar canes, soy beans, canola seeds, wheat grain, sugar beets, sorghum grain, etc.) supplied by multiple sources (e.g., multiple farms and multiple fields at each farm). The relative quantity of agricultural residues that are collected for utilization can be different for each source, depending on the agricultural conditions (e.g., soil fertility and erosion risks), the agricultural systems employed (e.g., full, low, or no till agriculture), and the farming machinery and equipment employed at each source. Second, agricultural residues collected from each biofuel feedstock source may be divided and utilized in multiple processes with distinct implications for carbon intensity and environmental performance. For example, one portion may be displace coal used in a power plant, another portion may be used to produce electricity in a dedicated bio-energy facility to supply electricity to the local power grid, and other portion may be used in a pyrolysis unit to produce liquid fuels, biochar, and electricity. Accounting for the utilization of all residues used in particular facilities, without accounting for the source of those residues, may not provide sufficient resolution because the residues used in various processes may be collected from multiple sources, not all of which may be associated with biofuel production, or biofuel production at a particular bio-refinery. As a result, it may be that agricultural residues utilized in a particular facility may be associated with biofuels produced at multiple bio-refineries.

Conducting unique lifecycle analyses for each unit of biofuel produced can be challenging. The invention features a system for actively tracking, accounting, and reporting agricultural residue utilization associated with each unit of biofuels produced, which can be implemented for appropriate LCA methodologies in real world applications to realize the full benefits of reduced carbon intensities and improved environmental performance. The process for associating units of biofuel produced with pre-defined LCA results can substantially improve the efficiency of documenting and realizing the full benefits (e.g., including regulatory, market, and pricing benefits) of reduced fuel carbon intensity and improved environmental performance The invention features a method and machine for achieving both of these objectives: tracking, accounting, and reporting agricultural residue utilization associated with each unit of biofuels produced; and associating biofuels produced with pre-defined LCA results according to residue utilization.

The invention is particularly relevant in the context of existing and emerging regulatory frameworks that are based on pre-established fuel production pathways with associated LCA studies, although the invention can be applied to fuels produced from algae (including various types of aquatic organisms) requiring CO₂ as an input to production and can be applied to fuels and related products produced from hydrocarbons that use CO2 or other fluid as an input to production.

In one aspect, there is a method including tracking, by a computing device, feedstock of an agricultural biomass through a first supply chain; tracking, by the computing device, residue of the agricultural biomass through a second supply chain; and determining, by the computing device, a quantity of fuel, produced from the feedstock, having a carbon intensity value based on utilization of the residue in the second supply chain.

In another aspect, there a computer program product, tangibly embodied in a computer-readable storage medium, including instructions being operable to cause a data processing apparatus to track feedstock of an agricultural biomass through a first supply chain and residue of the agricultural biomass through a second supply chain. The instructions are operable to cause the data processing apparatus to determine a quantity of fuel, produced from the feedstock, having a carbon intensity value based on utilization of the residue in the second supply chain.

In yet another aspect, there is a system including a computing processor configured to track feedstock of an agricultural biomass through a first supply chain and residue of the agricultural biomass through a second supply chain. The computing processor is configured to determine a quantity of fuel, produced from the feedstock, having a carbon intensity value based on utilization of the residue in the second supply chain.

In still another aspect, there is a system including means for tracking feedstock of an agricultural biomass through a first supply chain, means for tracking residue of the agricultural biomass through a second supply chain, and means for determining a quantity of fuel, produced from the feedstock, having a carbon intensity value based on utilization of the residue in the second supply chain.

In another aspect, there is a method including creating, by a computing device, for biofuel feedstock, a feedstock entry in a database. The feedstock entry includes feedstock information (i) characterizing biofuel derived from the biofuel feedstock and (ii) including a carbon intensity value for the biofuel. The method includes creating, by the computing device, for feedstock residue, a residue entry in the database. The residue entry includes residue information (i) characterizing the feedstock residue, (ii) including a cross-reference to the feedstock from which the feedstock residue is produced, and (iii) including a credit for utilization of the feedstock residue. The method also includes utilizing, by the computing device, the cross-reference to apply the credit to the carbon intensity value of the biofuel to determine a revised carbon intensity value for the biofuel.

In still another aspect, there a computer program product, tangibly embodied in a computer-readable storage medium, including instructions being operable to cause a data processing apparatus to carry-out the aforementioned process. In yet another aspect, there is a including a computing processor configured to carry-out the aforementioned process.

In still another aspect, there is a method including receiving, by a computing device, information about residue derived from agricultural biomass. The information includes a source for the residue, a quantity of the residue, and a utilization of the residue. The method includes creating, by the computing device, for the residue, a residue entry in a database. The residue entry includes the residue information. Fuel produced from feedstock derived from the agricultural biomass is identified by the computing device. The method includes updating, by the computing device, the residue entry in the database to include a cross-reference to the fuel. In various embodiments, the method includes using, by the computing device, the residue information to determine a credit for the residue; applying, by the computing device, the credit to the fuel; and determining, by the computing device, a carbon intensity value for the fuel. Prior to determining the credit, indicia of a trigger event related to delivery of the residue can be received by the computing device.

In yet another aspect, there a computer program product, tangibly embodied in a computer-readable storage medium, including instructions being operable to cause a data processing apparatus to carry-out the aforementioned method. In yet another aspect, there is a including a computing processor configured to carry-out the aforementioned method.

In another aspect, there is an apparatus including means for receiving information about residue derived from agricultural biomass, means for creating, for the residue, a residue entry in a database, and means for identifying fuel produced from feedstock derived from the agricultural biomass, and means for updating the residue entry in the database to include a cross-reference to the fuel.

In other examples, any of the aspects above, or any apparatus, system or device, or method, process or technique, described herein, can include one or more of the following features.

In various embodiments, a credit for utilization of the residue is determined based on a quantity of the residue used and a type of use of the residue. The residue is matched to the feedstock derived from the same agricultural biomass source. The credit is applied to the fuel, and the quantity of fuel having the carbon intensity value is determined.

In some embodiments, the second supply chain can include a plurality of different types of uses for the residue. A plurality of credits is determined for utilization of the residue. Each credit is based on a quantity of the residue used in one of the different types of uses and the different type of use of the residue. For each use, the residue is matched to the feedstock derived from the same agricultural biomass source. The plurality of credits is applied to the fuel, and the quantity of fuel having the carbon intensity value is determined.

In various embodiments, the fuel is derived from multiple sources of agricultural biomass. A credit for utilization of the residue is determined based on a quantity of the residue used and a type of use of the residue. The residue is matched to the feedstock derived from the same agricultural biomass source. The credit is applied to the fuel, and the quantity of fuel having the carbon intensity value is determined.

In some embodiments, the feedstock is distributed to multiple fuel processing plants. A credit for utilization of the residue is determined based on a quantity of the residue used and a type of use of the residue. For each fuel processing plant, the residue is matched to the feedstock derived from the same agricultural biomass source. A fraction of the credit is applied to the fuel produced by the fuel processing plant, and the quantity of fuel having the carbon intensity value is determined.

In certain embodiments, the carbon intensity value (or the revised value) is used to qualify the fuel as compliant with a regulatory framework. Tracking can include documenting at least one of progress of the feedstock through the first supply chain or progress of the residue through the second supply chain.

In certain embodiments a report authenticating the carbon intensity value for the fuel is compiled, which includes obtaining and compiling documents authenticating quantities and sources for each step in each of the first supply chain and the second supply chain, and documenting chain of custody for the feedstock and the residue. The feedstock information and the residue information can include information about quantities and sources for each of the feedstock and the residue. A report authenticating the carbon intensity value for the fuel is compiled, including obtaining and compiling documents authenticating the quantities and sources for each of the feedstock and the residue, and documenting chain of custody for the feedstock and the residue.

The cross-reference can be based on a geographic location where the agricultural biomass is produced or on a legal entity responsible for producing the agricultural biomass. The database can include a module for feedstock entries and a module for residue entries. The feedstock information can include an identifier for the biofuel feedstock and a quantity of the biofuel feedstock utilized to determine the cross-reference to the feedstock that is assigned to the feedstock residue. The residue information can include a quantity of the feedstock residue utilized to determine the credit for utilization of the feedstock residue. A plurality of residues derived from an agricultural biomass can be tracked for each unit of the biofuel produced.

In another aspect, there is a method including tracking, through a supply chain, by a computing device, a carbon containing process input; tracking, through the supply chain, by the computing device, a hydrocarbon fluid extracted from Earth by injecting the carbon containing process input into a subterranean environment; and determining, by the computing device, a quantity of fuel, produced from the hydrocarbon fluid, having a carbon intensity value based on sequestration of the carbon containing process input in the subterranean environment and utilization of at least one co-product of the carbon containing process input in the supply chain.

In still another aspect, there a computer program product, tangibly embodied in a computer-readable storage medium, including instructions being operable to cause a data processing apparatus to track, through a supply chain, a carbon containing process input and to track, through the supply chain, a hydrocarbon fluid extracted from Earth by injecting the carbon containing process input into a subterranean environment. The instructions are operable to cause the data processing apparatus to determine a quantity of fuel, produced from the hydrocarbon fluid, having a carbon intensity value based on sequestration of the carbon containing process input in the subterranean environment and utilization of at least one co-product of the carbon containing process input in the supply chain.

In yet another aspect, there is a system including a computing processor configured to track, through a supply chain, a carbon containing process input and to track, through the supply chain, a hydrocarbon fluid extracted from Earth by injecting the carbon containing process input into a subterranean environment. The computing processor is configured to cause the data processing apparatus to determine a quantity of fuel, produced from the hydrocarbon fluid, having a carbon intensity value based on sequestration of the carbon containing process input in the subterranean environment and utilization of at least one co-product of the carbon containing process input in the supply chain.

In still another aspect, there is an apparatus including means for tracking, through a supply chain, a carbon containing process input, and means for tracking, through the supply chain, a hydrocarbon fluid extracted from Earth by injecting the carbon containing process input into a subterranean environment. The apparatus includes means for determining a quantity of fuel, produced from the hydrocarbon fluid, having a carbon intensity value based on sequestration of the carbon containing process input in the subterranean environment and utilization of at least one co-product of the carbon containing process input in the supply chain.

In another aspect, there is a method including receiving, by a computing device, information about a carbon containing process input. The information includes a source for the carbon containing process input, a quantity of the carbon containing process input, and a quantity of the carbon containing process input sequestered in a subterranean environment. The method includes creating, by the computing device, for the carbon containing process input, an entry in a database. The entry includes the information. The method further includes identifying, by the computing device, fuel produced by injecting the carbon containing process input into the subterranean environment to extract a hydrocarbon fluid used in production of the fuel, and updating, by the computing device, the entry in the database to include a cross-reference to the fuel. In various embodiments, the method includes using, by the computing device, the information to determine a credit for the carbon containing process input; applying, by the computing device, the credit to the fuel; and determining, by the computing device, a carbon intensity value for the fuel.

In still another aspect, there is a computer program product, tangibly embodied in a computer-readable storage medium, including instructions being operable to cause a data processing apparatus to receive information about a carbon containing process input, create an entry including the information in a database for the carbon containing process input, identify fuel produced by injecting the carbon containing process input into the subterranean environment to extract a hydrocarbon fluid used in production of the fuel, and update the entry in the database to include a cross-reference to the fuel. In various embodiments, the instructions are operable to cause the data processing apparatus to determine a carbon intensity value for the fuel based on a credit for the carbon containing process input.

In another aspect, there is a system including a computing processor configured to receive information about a carbon containing process input, create an entry including the information in a database for the carbon containing process input, identify fuel produced by injecting the carbon containing process input into the subterranean environment to extract a hydrocarbon fluid used in production of the fuel, and update the entry in the database to include a cross-reference to the fuel. In various embodiments, the computing processor is configured to cause the data processing apparatus to determine a carbon intensity value for the fuel based on a credit for the carbon containing process input.

In other examples, any of the aspects above, or any apparatus, system or device, or method, process or technique, described herein, can include one or more of the following features.

In various embodiments, a credit for sequestration of the carbon containing process input in the subterranean environment is determined based on a quantity of the carbon containing process input sequestered and a source of the carbon containing process input. The credit is applied to the fuel, and the quantity of fuel having the carbon intensity value is determined.

In some embodiments, a credit for utilization of the at least one co-product of the carbon containing process input is determined based on a quantity of the at least one co-product and a source of the at least one co-product. The credit is applied to the fuel, and the quantity of fuel having the carbon intensity value is determined.

The carbon containing process input can be carbon dioxide or a carbon dioxide fluid. The carbon containing process input can be derived from atmospheric carbon dioxide or captured as waste from an industrial facility. The carbon intensity value can be used to qualify the fuel as compliant with a regulatory framework. In certain embodiments, a tradable credit is generated from the carbon intensity value for the fuel, and the fuel having the tradable credit is traded on an emission trading market. Tracking can include documenting at least one of progress of the carbon containing process input or progress of the hydrocarbon fluid through the supply chain.

In some embodiments, a report authenticating the carbon intensity value for the fuel is compiled, which can include obtaining and compiling documents authenticating quantities and sources for each step in the supply chain, and documenting chain of custody for the carbon containing process input.

In another aspect, there is a method including tracking, through a supply chain, by a computing device, a carbon containing process input and tracking, through the supply chain, by the computing device, algae cultured using the carbon containing process input. The method includes determining, by the computing device, a quantity of fuel, produced from the algae, having a carbon intensity value based on sequestration of the carbon containing process input in the algae and utilization of at least one co-product of the carbon containing process input in the supply chain.

In still another aspect, there a computer program product, tangibly embodied in a computer-readable storage medium, including instructions being operable to cause a data processing apparatus to track a carbon containing process input through a supply chain and to track algae cultured using the carbon containing process input through the supply chain. The instructions are operable to cause the data processing apparatus to determine a quantity of fuel, produced from the algae, having a carbon intensity value based on sequestration of the carbon containing process input in the algae and utilization of at least one co-product of the carbon containing process input in the supply chain.

In yet another aspect, there is a system including a computing processor configured to track a carbon containing process input through a supply chain and to track algae cultured using the carbon containing process input through the supply chain. The computing processor is configured to determine a quantity of fuel, produced from the algae, having a carbon intensity value based on sequestration of the carbon containing process input in the algae and utilization of at least one co-product of the carbon containing process input in the supply chain.

In still another aspect, there is an apparatus including means for tracking a carbon containing process input through a supply chain, means for tracking algae cultured using the carbon containing process input through the supply chain, and means for determining a quantity of fuel, produced from the algae, having a carbon intensity value based on sequestration of the carbon containing process input in the algae and utilization of at least one co-product of the carbon containing process input in the supply chain.

In another aspect, there is a method including receiving, by a computing device, information about a carbon containing process input. The information includes a source for the carbon containing process input, a quantity of the carbon containing process input, and a quantity of the carbon containing process input sequestered in algae. The method includes creating, by the computing device, for the carbon containing process input, an entry including the information in a database. The method also includes identifying, by the computing device, fuel produced from the algae, and updating, by the computing device, the entry in the database to include a cross-reference to the fuel. In various embodiments, the method includes using, by the computing device, the information to determine a credit for the carbon containing process input; applying, by the computing device, the credit to the fuel; and determining, by the computing device, a carbon intensity value for the fuel.

In yet another aspect, there is a computer program product, tangibly embodied in a computer-readable storage medium, including instructions being operable to cause a data processing apparatus to receive information about a carbon containing process input. The information includes a source for the carbon containing process input, a quantity of the carbon containing process input, and a quantity of the carbon containing process input sequestered in algae. The instructions are operable to cause the data processing apparatus to create, for the carbon containing process input, an entry including the information in a database, identify fuel produced from the algae, and update the entry in the database to include a cross-reference to the fuel.

In another aspect, there is a system including a computing processor configured to receive information about a carbon containing process input. The information includes a source for the carbon containing process input, a quantity of the carbon containing process input, and a quantity of the carbon containing process input sequestered in algae. The computing processor is configured to create, for the carbon containing process input, an entry including the information in a database, identify fuel produced from the algae, and update the entry in the database to include a cross-reference to the fuel.

In still another aspect, there is an apparatus including means for receiving information about a carbon containing process input, means for creating, for the carbon containing process input, an entry including the information in a database, means for identifying fuel produced from the algae, and means for updating, by the computing device, the entry in the database to include a cross-reference to the fuel.

In other examples, any of the aspects above, or any apparatus, system or device, or method, process or technique, described herein, can include one or more of the following features.

In various embodiments, a credit for sequestration of the carbon containing process input in the algae is determined based on a quantity of the carbon containing process input sequestered and a source of the carbon containing process input. The credit is applied to the fuel, and the quantity of fuel having the carbon intensity value is determined.

In some embodiments, a credit for utilization of the at least one co-product of the carbon containing process input is determined based on a quantity of the at least one co-product and a source of the at least one co-product. The credit is applied to the fuel, and the quantity of fuel having the carbon intensity value is determined.

In various embodiments, the carbon containing process input is carbon dioxide (e.g., derived from atmospheric carbon dioxide or captured as waste from an industrial facility). The carbon intensity value can be used to qualify the fuel as compliant with a regulatory framework. In certain embodiments, a tradable credit is generated from the carbon intensity value for the fuel, and the fuel having the tradable credit is traded on an emission trading market. Tracking can include documenting at least one of progress of the carbon containing process input or progress of the algae through the supply chain.

In certain embodiments, a report authenticating the carbon intensity value for the fuel is compiled, which includes obtaining and compiling documents authenticating quantities and sources for each step in the supply chain, and documenting chain of custody for the carbon containing process input.

In various embodiments, the co-product includes one or more of electricity, heat, and power. Producing the co-product can include producing electricity from a combination of second fraction and coal. The co-product can include one or more of a cellulosic biofuel, solid biofuel, bio-char, bio-chemical, bio-plastic, building material, construction material, paper pulp, animal feed, and soil amendment.

In some embodiments, the co-product prevents carbon from the second fraction from flowing to the atmosphere.

In certain embodiments, the co-product is a substitute for a fossil hydrocarbon product, thereby preventing carbon from a fossil hydrocarbon product from flowing to the atmosphere.

In various embodiments, the method includes trading the biofuel having the regulatory value, a tradable credit generated as a function of the regulatory value, or both the biofuel and the tradable credit. A method can include completing a transaction to sell a low carbon fuel to a transportation fuel provider.

In some embodiments, the greenhouse gas emission comprises carbon emission. In general, greenhouse gas can include one or more gases that in the atmosphere absorb and emit radiation within the thermal infrared range. Greenhouse gas emission can include, for example, the emission of any one or more of: carbon dioxide, methane, nitrous oxide, and ozone.

It is understood by those skilled in the art that the various aspects and features described herein can be adapted and combined with the various embodiments of the invention. The advantages of the technology described above, together with further advantages, may be better understood by referring to the following description taken in conjunction with the accompanying drawings. The drawings are not necessarily to scale, emphasis instead generally being placed upon illustrating the principles of the technology.

### DESCRIPTION OF THE DRAWINGS

FIG. 1A shows an example biofuel production process schematic and FIG. 1B shows an example WCBP process schematic.

FIGS. 2A and 2B show examples of biofuel production and FIG. 2C shows an example WCBP, in the context of corn and corn ethanol.

FIG. 3A-D shows biogenic carbon flows in different examples of the production and use of corn ethanol.

FIGS. 4A and 4B shows example process schematics for lifecycle emissions accounting.

FIG. 5 illustrates a TARM system.

The invention will now be described in detail with respect to the preferred embodiments and the best mode in which to make and use the invention. Those skilled in the art will recognize that the embodiments described are capable of being modified and altered without departing from the teachings herein.

### DETAILED DESCRIPTION OF THE INVENTION

The invention, including WCBP, provides methods of accounting for carbon flows and determining a regulatory value for a biofuel, method of engineering carbon cycles for biofuel production, and methods of manufacturing biofuels, as well as the biofuels and regulatory values derived therefrom. For example, the invention includes integrated systems, processes, and methodologies for producing biofuels, including first generation biofuels, with substantially reduced net greenhouse gas emissions and carbon intensities and substantially improved sustainability performance (e.g., relative to conventional biofuels). In various embodiments, WCBP can include various combinations of four general components: (i) agricultural production; (ii) biofuel production; (iii) agricultural residue utilization; and (iv) greenhouse gas accounting and/or sustainability assessment, in which utilization of a fraction of the biomass (e.g., agricultural residue) provides LCA emissions accounting credits and/or sustainability benefits to be associated with the biofuel product. These components can be interrelated and/or integrated (e.g., in a single supply/production chain).

The invention features a tracking, accounting, and reporting machine and method, which can provide in the case of WCBP parallel tracking of biofuel feedstock and associated residues through their respective supply chains, the computation of resulting fuel CI values that reflect actual residue utilization rather than simplified assumptions, consolidated reporting of resulting CI values, and/or compilation of documentation evidencing CI computation and assignment. In other words TARM methods can compute the CI (carbon intensity) for a given quantity of biofuel based on both the biofuel-feedstock supply chain and the agricultural residues supply chain. In the case of algae, algal biofuels and/or related products the TARM can provide tracking of CO₂ and/or other inputs across potentially multiple sources, the computation of resulting CI values that reflect actual supply chains (including potential co-products) rather than simplified assumptions, consolidated reporting of resulting CI values, and/or compilation of documentation evidencing CI computation and assignment. In the case of hydrocarbons, hydrocarbon fuels, and/or related products the TARM can provide tracking of CO₂ and/or other inputs across potentially multiple sources, the computation of resulting CI values that reflect actual supply chains (including potential co-products, CO₂ sequestration in geologic formations, and/or potential leakage rates) rather than simplified assumptions, consolidated reporting of resulting CI values, and/or compilation of documentation evidencing CI computation and assignment.

Such TARM methods are uniquely interrelated with various methods of the invention (e.g., WCBP), algae production, hydrocarbon production, and/or regulations relying on lifecycle accounting of CI and/or other sustainability performance metrics. Prior to the invention and/or these types of regulation, no such system was ever been developed, disclosed, or even conceived, as there would not have been any benefit. In the case of WCBP there would be no benefit from parallel tracking and data integration across these supply chains (e.g., biofuel and residue supply chains) without both (i) LCA based performance metrics, as provided by emerging fuel regulations and (ii) biofuel supply chains that define environmental performance as a function of the residue supply chain's environmental performance. In the case of algae and hydrocarbons there would no benefit from detailed tracking of the supply chains, co-products from, and geologic sequestration of CO₂ and/or other production inputs without both (i) LCA based performance metrics, as provided by emerging fuel regulations, and (ii) supply chains that define environmental performance as a function of the supply chains, co-products, and CO₂ sequestration associated with CO₂ supply.

Additional features of the TARM methods provide algorithms for computing in the case of WCBP the quantity of biofuel with a predefined CI value based on the quantity of residues used in a particular application. In the case of algae, algae fuels, hydrocarbons, hydrocarbon fuels, and/or related products the TARM methods provide algorithms for computing the quantity of algae, algal fuel, hydrocarbons, hydrocarbon fuels, and/or related products with a predefined CI value based on the quantity(ies) and source(s) of CO₂, related co-products, and associated CO₂ sequestration used in a particular application. The invention allows measurable information from the supply chain to compute the quantity of fuels and/or related products produced in a manner that is consistent with pre-defined regulatory CI values. It solves the practical challenges that arise because LCA assumptions include variables with continuous ranges (e.g., the quantity of residues removed with biofuel feedstock production, the quantity of CO₂ supplied from a particular source, etc.) rather than discrete potential values (were residues removed or not, was CO₂ from a particular source supplied or not).

For example, if you harvest 50% of the residues from field A and 0% of the residues from field B, then you can define the quantity of biofuel produced according to: (A) the quantities of fuel produced according to pathways that includes 50% and 0% residue utilization (in which case ˜half of the fuel would be assigned to each pathway); OR (B) the quantity of biofuel produced according to a pathway that includes 25% residue utilization (which would be ˜100% of the fuel produced). In fact there are an infinite number of fuel quantities that might be computed depending on the residue utilization rates reflected in the predefined fuel pathways. The computations for doing this turn fuel CI assignments on their head—most view the quantity of fuel as fixed/measurable and define the CI according to the supply chain, this assumes the CI values are fixed by predefined fuel pathways, and assigns fuel quantities across them according to supply chain data. This method of computing the quantity of fuel produced according to pre-defined fuel pathways as a function of quantities measured within actual supply chains is applicable to other potential supply chains too, as noted in the examples below (e.g., Examples 10 and 11).

The invention is particularly relevant in the context of existing and emerging regulatory frameworks that are based on pre-established fuel production pathways with associated LCA studies. In this context, tools for associating specific quantities of biofuels with specific fuel production pathways and LCA results are needed that are practical to implement, scientifically robust, and rigorously defensible/explicitly documented. For example, a tracking system can include (but is not limited to): Option 1—tracking for each bio-refinery, feedstock source, residue collected, and residue utilization and/or Option 2—tracking for each unit of residues, bio-refinery, feedstock source, and utilization.

Systems for associating biofuels with pre-specified LCA results can include (but are not limited to): Option 1—Weighted average methodology (average across residue utilizations, recognizing linkage to and limits of associated feedstock source) and/or Option 2—Dividing biofuels into portions, each of which can be assigned to individual LCAs of pre-specified biofuel production pathways.

Machine+algorithm implementations can include (but are not limited to):
Define and store on a machine values associated with pre-specified LCAs for each residue utilization option (along with LCA descriptors/labels/codes);
Physically track, document, and store on a machine values associated with:
   i. For each bio-refinery associated with each unit of residue collected (including, e.g., the quantity of biomass feedstock from each source) and the residue utilization (along with values describing key residue characteristics like moisture, residue type, heating value, etc.)
   ii. For each unit of biofuel produced, one or more of:
      1. The quantity of residue utilized in each possible utilization system (e.g., optionally with values describing key residue characteristics like moisture, residue type, heating value, etc.),
      2. Values characterizing the quantities of feedstock as well as residues utilized from each source (i.e., for each bio-refinery feedstock source, a source identifier, the quantity of feedstock, the total quantity of residues utilized, and the quantity allocated to each residue utilization system),
      3. Key environmental performance criteria &/or other supporting documentation, such as: Sustainability certifications, approved residue removal rates, validation of approved verses actual removal rates;
      4. Links to records of product transfer documents (biofuel feedstock & residue quantities for each supplier and utilization system).
Compute:
   i. Weighted average LCA result across residue utilization systems; or
   ii. Fractions of biofuel produced that are associated with each feedstock utilization system and associated LCA result.
Associate/allocate
   i. Weighted average LCA result to total quantity of biofuels produced; or
   ii. Residue-utilization-specific LCA results to specific partitions of the total quantity of biofuel produced.

Thus, in various aspects, the invention provides for a structure for documenting residue tracking, accounting, and reporting systems. Whereas, fuel quantity can be viewed as a measurable value, even when multiple co-product mixes are possible because the quantity produced in each plant configuration can be effectively measured. With TARM and WCBP, a fuel pathway can be cast as depending on agricultural residue utilization, which is beyond the control of biofuel producers and can vary considerably even within a single batch of biofuels produced. As a result, the quantity of fuel produced according to each pathway can be specified according to the quantity of residues used in each residue application.

In particular, the quantity of fuel produced at a biorefinery is generally viewed to be a measurable quantity, documented by, among other things, sales receipts for fuel products sold. However, for the purposes of the CA-LCFS and other regulatory frameworks governing fuel carbon intensity (CI), this is not always the case. There are a variety of reasons for this; one example is that the mix of fuel co-products can vary according to operator management decisions.

In the case of WCBP, and related production systems that include utilization of agricultural residues produced as a consequence of biofuel feedstock supply, this can be particularly challenging. This is because the quantity of agricultural residues utilized and the systems in which the residues are utilized are: (i) beyond the control of biorefinery operators; (ii) variable across feedstock producers (and even fields operated by a single feedstock producer); and (iii) variable over time. The first of these factors represents fundamental characteristics of biofuel supply chains, which are generally not subject to complete vertical integration; however, this can be resolved prospectively via contractual relationships. The second and third factors reflect fundamental sensitivities of feedstock removal to site specific characteristics of agricultural production areas. In particular, the quantity of agricultural residues that may be removed from a field depends on diverse factors that vary by area and over time. Each of these factors is further confounded by the relative immaturity and rapidly evolving nature of agricultural residue removal and utilization, which substantially increases the variability in both quantities of residues removed and the applications in which those residues are utilized. Novel systems of tracking and accounting are required to resolve these issues.

The quantity of biofuels produced (Q_{f}) is often viewed as a measurable quantity and the carbon intensity of the fuel (CI_{f}) is often viewed as a value that can be specified a priori according to the production system specification, including product and co-product mix. In the case of WCBP, this includes the quantity of residues removed (Q_{R}) and the utilization of those residues (U_{R}). This can be represented as:

Q_{f}=measurable quantity

CI_{f}=f(Qs,U_{R}, . . . ,)

For compliance with LCFS and related regulations governing fuel CI, biorefineries must report production according to pre-defined fuel pathways, which account for the production system specification, including the mix of products and co-products. This complicates reporting because the co-product mix can vary within a single refinery. In the case of WCBP, decisions regarding the co-product mix are beyond the control of biorefinery operators. Moreover, a single refinery and even a single batch of biofuel can be associated with multiple fuel pathways because (i) agricultural residues associated with a batch of biofuels can be used in multiple types of applications and (ii) agricultural removal rates, defined per megajoule of biofuel (Q_{R}/MJ_{f}) can vary across biofuel feedstock suppliers and over time. As a result, the quantity of a fuel produced according to a particular fuel pathway (Q_{fp}) depends on the quantity of residues utilized and the application in which they are utilized. This can be represented as:

Qfp=f(Q_{R},U_{R})

CI_{fp}=f(Q_{R},U_{R}, . . . ,)

Several options exist for accommodating these dependencies and the inherent variability in residue removal rates and utilizations. One option is to define fuel pathways a priori according to average residue removal rates and the average co-product mix. This can be consistent with the approaches adopted in the specification of other fuel pathways. However, this can fail to capture or properly motivate innovation in agricultural residue utilization, which is occurring rapidly and being driven by only certain biofuel producers. Moreover, average values are likely not reliable or representative in the case of fuel production pathways with residue utilization, due to the immature and rapidly evolving nature of residue utilization. As a result, this approach may be inappropriate and/or impractical.

An alternate approach is for biorefineries to actively track the usage of agricultural residues and report average usage a posteriori. Averaging across the industry as a whole can be inappropriate for the reasons noted above (e.g., wide variability, fails to recognize & motivate innovation driven by a subset of biofuel producers, etc.); however, alternatively, this approach can be adopted on a biorefinery-specific basis, in which a biorefinery can track and report the usage of residues resulting from its biofuel feedstock supply. This can be consistent with the averaging approach adopted in other fuel pathway definitions. Achieving this in practice requires new systems for tracking and accounting for agricultural residue utilization within each refineries supply chain. Systems for accomplishing this are a subject of the invention. While this may prove to be effective, it implies updating fuel pathway definitions and carbon intensity values annually according to actual residue utilization profiles, which may prove impractical.

A third approach, which is also a subject of the invention, is to: (i) define multiple fuel pathways a priori on the basis of alternate residue utilization (and potentially alternate removal rates); (ii) track actual residue removal rates and residue utilization; and (iii) define and report the quantity of fuel produced according to each fuel pathway on the basis of the quantities of residues utilized in each application (Qₛᵤ). This can be represented as:

Q_{fp}=f(Q_{Ru})

CI_{fp}=f(Q_{R},U_{R}, . . . ,)

The invention also applies to biofuels produced from algae (including various types of aquatic organisms) require CO₂ as an input to production (e.g., CO₂ is delivered to an algae culture with water and nutrients to produce algal biomass, fuels, chemicals, and/or related products). The CO₂ and/or other inputs can be supplied from a variety of sources that can impact the lifecycle analysis of resulting fuels and related products. For example, CO₂ for algae production can be supplied from biomass via a variety of conversion technologies resulting in one or more co-products. In this case the LCA may provide credits for atmospheric CO₂ captured via photosynthesis and/or emissions effects associated with the co-products of CO₂ supply. In another example, the CO₂ for algae production can be supplied from the atmosphere via industrial “air capture” processes. In this case the LCA may provide credits for using CO₂ captured from the atmosphere. In another example, the CO₂ for algae production can be provided from other industrial processes that yield other co-products, including but not limited to electricity, cement and other mineral products, chemical products, other fuel products, etc. In this case the LCA may provide credits for the emissions effects associated with the co-products of CO₂ supply. CO₂ can be supplied by any combination of the types of sources mentioned above, in which case the LCA can provide a combination of the various types of associated credits. Each of these various LCA's can be used to characterize a distinct fuel or product pathway or supply chain for algae, algal fuels and/or related products.

In this context, tools for associating specific quantities of algal biofuels and related products with specific fuel production pathways and LCA results are needed that are practical to implement, scientifically robust, and rigorously defensible/explicitly documented. For example, a tracking system can include (but is not limited to): Option 1—tracking for each algae production facility, the CO₂ source and the CO₂ supply co-products; and/or Option 2—tracking for each unit of CO₂ supplied, the algae production facility, the CO₂ source, and the CO₂ supply co-product(s).

Systems for associating algae biofuels and/or related products with pre-specified LCA results can include (but are not limited to): Option 1—Weighted average methodology (average across CO₂ sources, recognizing linkage to and limits of associated co-products) and/or Option 2—Dividing algal biofuels and/or related product batches into portions, each of which can be assigned to individual LCAs of pre-specified biofuel production pathways.

The invention also applies to fuels and related products produced from hydrocarbons that use CO₂ or other fluid as an input to production (e.g., CO₂ or other fluid is delivered to a geologic formation from which hydrocarbons are produced in a manner that may enable some fraction of the CO₂ or other fluid to be sequestered away from the atmosphere—in the geologic formation—for time periods relevant to advancing climate and/or other environmental policy objectives). The CO₂ and/or other fluids used for hydrocarbon production can be supplied from a variety of sources that can impact the lifecycle analysis of resulting fuels and related products. For example, CO₂ for hydrocarbon production can be supplied from biomass via a variety of conversion technologies resulting in one or more co-products. In this case the LCA may provide credits for using atmospheric CO₂ captured via photosynthesis, for sequestering this atmospheric CO₂ in the geologic formation, and/or for emissions effects associated with the co-products of CO₂ supply (with or without considering CO₂ sequestration in the geologic formation). In another example, the CO₂ for hydrocarbon production can be supplied from the atmosphere via industrial “air capture” processes. In this case the LCA may provide credits for using CO₂ captured from the atmosphere, sequestering the atmospheric CO₂ in the geologic formation, and/or emissions effects associated with any co-products of the industrial process for capturing CO₂ from the atmosphere (with or without considering CO₂ sequestration in the geologic formation). In another example, the CO₂ for hydrocarbon production can be provided from other industrial processes that yield other co-products, including but not limited to electricity, cement and other mineral products, chemical products, other fuel products, etc. In this case the LCA may provide credits for the emissions effects associated with the co-products of CO₂ supply (with or without considering CO₂ sequestration in the geologic formation). CO₂ can be supplied by any combination of the types of sources mentioned above, in which case the LCA can provide a combination of the various types of associated credits. Each of these various LCA's can be used to characterize a distinct fuel or product pathway or supply chain for hydrocarbons, hydrocarbon fuels, and/or related products.

In this context, tools for associating specific quantities of hydrocarbons, hydrocarbon fuels and/or related products production pathways and LCA results are needed that are practical to implement, scientifically robust, and rigorously defensible/explicitly documented. For example, a tracking system can include (but is not limited to): Option 1—tracking for each hydrocarbon production facility, the CO₂ source, the CO₂ supply co-products, and the CO₂ sequestered in the geologic formation; and/or Option 2—tracking for each unit of CO₂ supplied, the hydrocarbon production facility, the CO₂ source, the CO₂ supply co-product(s), and the CO₂ sequestered in the geologic formation.

Systems for associating hydrocarbons, hydrocarbon fuels, and/or related products with pre-specified LCA results can include (but are not limited to): Option 1—Weighted average methodology (average across CO₂ sources, recognizing linkage to and limits of associated co-products and CO₂ sequestration rates) and/or Option 2—Dividing hydrocarbons, hydrocarbon fuels and/or related product batches into portions, each of which can be assigned to individual LCAs of pre-specified production pathways.

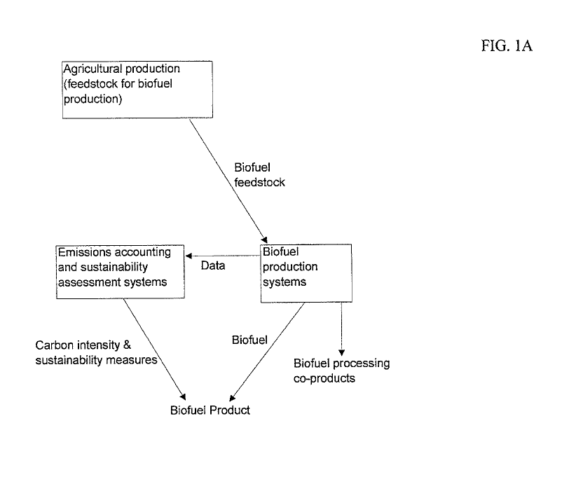

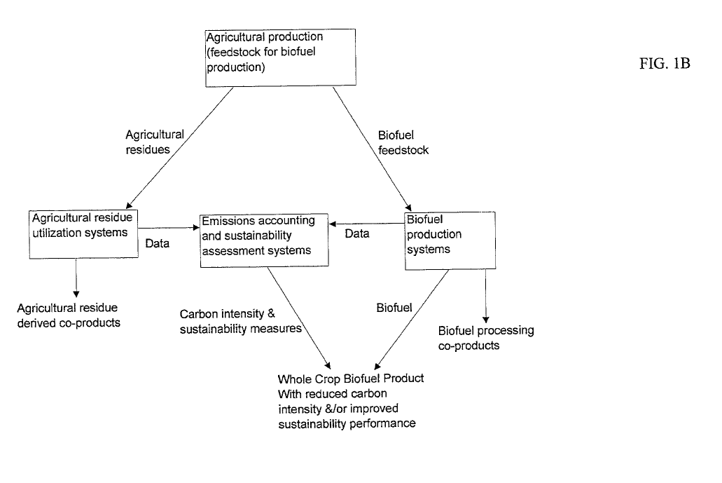

FIG. 1A shows an example biofuel production process schematic and FIG. 1B shows an example WCBP process schematic. In FIG. 1A, agricultural production produces a biofuel feedstock, which is then processed in a biofuel production system. In general, biofuel production results in a biofuel and data that can be assessed for CI and/or sustainability measures. The data can include agricultural production data that can be assessed for CI and sustainability measures. For example, the data can come only from biofuel production (with predefined values and/or assumptions regarding agricultural production and fuel use), or can come from the biofuel production, agricultural production, and fuel use. These measures can be used to define credits or debits, including tradable credits under certain regulatory frameworks. Note that tradable credits can be distinct from LCA accounting credits in their ability to be explicitly traded (e.g., bought and sold) under certain regulatory frameworks. The combination of these measures, or tradable credits or debits associated with these measures, and the biofuel can be traded as a biofuel product. In some cases, the biofuel and tradable credits, in whole or in part, can be traded separately. In a conventional system, biofuel co-products are generally limited to biofuel processing co-products (e.g., ethanol from the fermentation of corn kernels and animal feed from the corn kernel fermentation waste). In the illustrated embodiment, the WCBP process schematic FIG. 1B further shows agricultural residues being processed in an agricultural residue utilization system. The utilization of agricultural co-products produces agricultural residue derived co-products and co-product data that can also be assessed for CI and/or sustainability measures. Accordingly, the WCBP biofuel product can have a reduced carbon intensity and/or improved sustainability measure relative to the conventional process (e.g., even give the same agricultural production input and biofuel production system).

In general, a first fraction of the biomass can be a fraction of the biomass that is used as a biofuel feedstock (e.g., lipid and/or carbohydrate rich fraction in the example of a first generation biofuel). In general, the second fraction of the biomass can be a fraction of the biomass that is not used as a biofuel feedstock (though, in some embodiments, the second fraction can also be a biofuel feedstock, e.g., for a cellulosic biofuel). In various embodiments, the second fraction is or comprises an agricultural residue. The term agricultural residues is used here to describe biomass produced in agriculture, silviculture, and or aquaculture systems that is typically or historically not of sufficient value to be converted into salable product(s) and is therefore historically allowed to decompose in natural or modified environments (e.g., in the field, in compost, etc.), burned, or used as fodder or bedding in animal husbandry. Agricultural residues can be separated from the primary biofuel feedstock during harvesting (e.g., stalks, stems, leaves, etc.) or in post-harvest processing (e.g., shells, pods, hulls, etc.).

In general, the invention can be carried out by a single entity executing, arranging for and/or providing for the execution of the individual steps. For example, the single entity can contract for the completion of one or more individual steps (e.g., agricultural production, biofuel production, agricultural residue utilization, and/or greenhouse gas accounting and/or sustainability assessment). In some embodiments, the single entity might employ a preexisting framework or registration in carrying out the method (e.g., purchase a biofuel feedstock with an established CI and/or sustainability measure, or produce a biofuel with an established CI and/or sustainability measure) rather than ascertaining values for components of the pathway from scratch. Therefore, although the method integrates a wide variety of features from a long and complex supply chain/carbon cycle, the method is readily implemented by a single entity. For example, in the context of markets resulting from GHG/biofuel regulatory instruments and environments, several potential implementation models can be used to support WCBP. Potential implementation models can be differentiated based on the point in the supply chain responsible for WCBP implementation.

Implementation by independent operators. WCBP can be implemented by an independent operator based on the value of resulting tradable credits. In this case, the WCBP operator can purchase biomass and/or agricultural residues from biomass producers, process the biomass and/or agricultural residues (e.g., into a biofuel and co-product, or a co-product) and, qualify LCA emissions accounting credits under any or all relevant regulatory frameworks, market resulting tradable credits to regulated parties. One variant of this case can be for the WCBP operator to partner with a regulated party with standing under certain regulatory instruments (e.g., a biofuel producer regulated under a low carbon fuels standard) to qualify LCA emissions accounting credits and resultant tradable credits from WCBP implementation.

Implementation by regulated parties. WCBP can be implemented by a party with compliance requirements under one or more relevant regulatory frameworks (e.g., biofuel producer obligated under a low carbon fuel standard) based on the value of resulting tradable credits or allowances to the firm or on associated emissions trading markets. In this case, the regulated party can purchase biomass for WCBP jointly with or independently from their purchases of other biomass feedstock (e.g., agricultural residues along with corn kernels or soybeans for biofuel production). They can take responsibility for all of the processes mentioned above, but would have the additional options of retaining resulting tradable credits for their own compliance purposes or marketing them with their other products (e.g., biofuel) to regulated parties downstream in the supply chain in order to benefit from potential price premiums for low carbon products.

Implementation by biomass producers. WCBP can be implemented by a biomass producer. In many cases, resulting implementation models would be analogous to implementation by an independent operator. However, biomass producers implementing WCBP on biomass resulting as a co-product to primary biomass products (e.g., agricultural residues from production of feedstock for biofuel production) can profit from price premiums for primary products associated with lower embodied carbon emissions instead of qualification of LCA emissions accounting credits and sale of resulting tradable credits. This implementation model can be implemented in a stand-alone manner by biomass producers or in partnership with independent WCBP operators, regulated parties (e.g., biofuel producers), or both to leverage the particular contributions of each party (e.g., specialization of WCBP operators and regulatory standing of regulated parties).

Whole Crop Biofuel production systems are differentiated from other existing and proposed biofuel production systems in their utilization of the whole crop's biomass to maximize financial, environmental, climate, and other sustainability benefits, which can be relevant in a number of contexts, including for example evolving regulatory frameworks for advancing climate policy objectives. Relative to other existing and proposed biofuel production systems it can be viewed as: (i) systematically expanding process inputs and materials handling in the biofuel production systems to the whole crop biomass produced, rather than only starch, sugar, cellulosic, or lipid rich portions; (ii) balancing the expanded mix of products and co-products enabled by utilizing the whole crop biomass to maximize financial, climate, environmental, and sustainability benefits; and (iii) explicitly integrating the expanded product mix in lifecycle assessments of sustainability, environmental performance, greenhouse gas emissions, and carbon intensity to (a) substantially advance sustainability performance, (b) maximize potential emissions reductions, and (c) concentrate LCA accounting credits for such sustainability and emissions benefits on biofuel product(s), which can be associated with markets where the value of such emissions accounting credits, or resultant tradable credits, is expected to be particularly high. Examples include but are not limited to markets for low carbon biofuels and tradable credits issued for compliance with low carbon fuel standards.

Whole Crop Biofuels are fundamentally different in character from those resulting from other existing or proposed biofuel production systems with respect to unit-specific greenhouse gas emissions, also known as their carbon intensity, a measurable and regulated fuel property, and with respect to other potential metrics of biofuel sustainability adopted for regulatory or other purposes. Examples include those being developed or considered under low carbon fuel standards in California, Oregon, Washington, British Columbia, and a coalition of states in the Northeast and Mid-Atlantic region, the European Union's Renewable Energy and Fuel Quality Directives, and the United Kingdom's Renewable Transport Fuel Obligation.

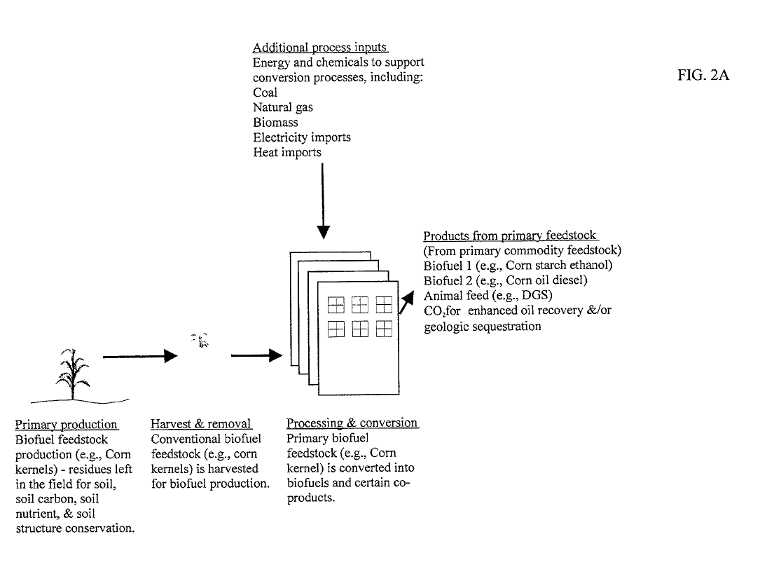

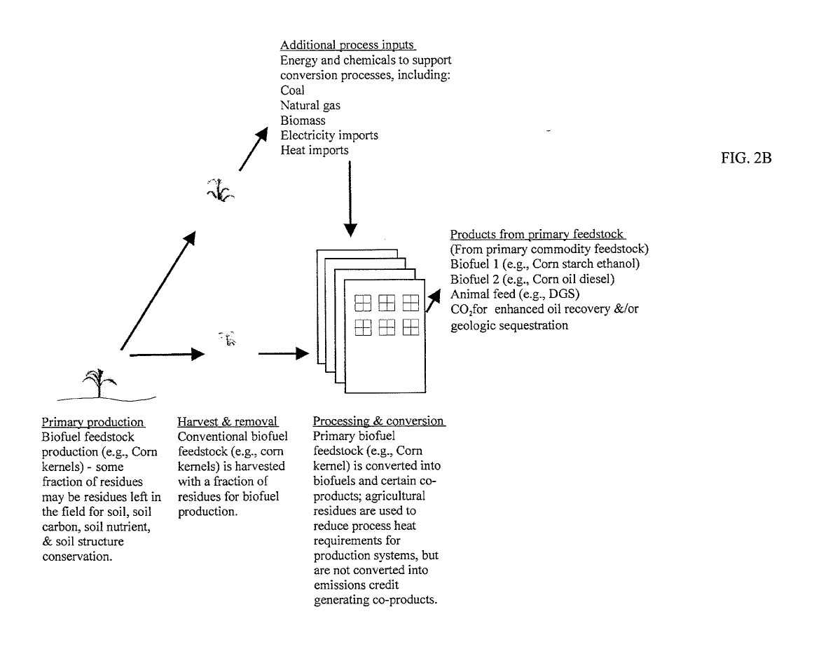

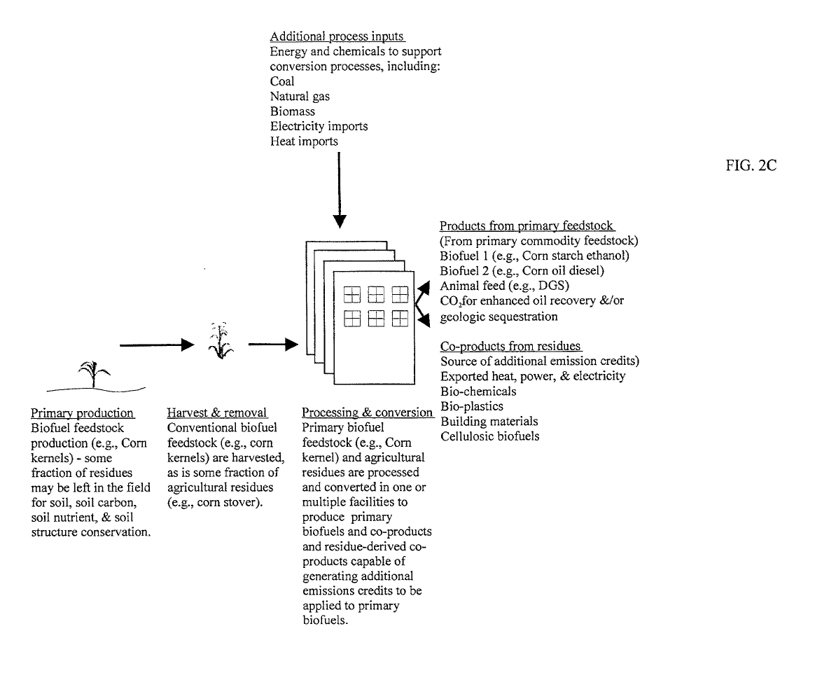

Certain distinctions between Whole Crop Biofuel Production and conventional biofuel production are shown in FIGS. 1A and 1B. FIG. 2 shows certain other distinctions. FIG. 2A shows an example of conventional biofuel production and FIG. 2C shows an example WCBP, in the context of corn and corn ethanol.

FIG. 2A shows an example of conventional biofuel production from corn with lifecycle carbon intensity reductions and sustainability benefits from (i) co-products of converting primary biofuel feedstock and (ii) use of reduced carbon intensity process inputs (e.g., natural gas &/or biomass fuel for process heat and power requirements).

FIG. 2B shows an example of biofuel production from corn, with agricultural residues used for process heat and power. Biofuel production can include additional lifecycle carbon intensity reductions and sustainability benefits from the use of agricultural residues as low carbon intensity process inputs (e.g., corn stover biomass utilization for process heat and power requirements in ethanol production).

FIG. 2C shows an example of WCBP. Biofuel production can include additional lifecycle carbon intensity reductions and sustainability benefits from the utilization of the whole crop biomass, including co-products from agricultural residue utilization. Note that the example of WCBP differs from the conventional production in that (i) a second fraction of the agricultural biomass is harvested and removed for processing and conversion, (ii) processing and conversion of the second fraction of the agricultural biomass includes the production of co-products, and (iii) the co-products result in a biofuel having an improved. CI and/or sustainability value.

Whole Crop Biofuel Production is not limited to the examples of corn ethanol shown in FIGS. 1 and 2. Selected additional examples are shown in Tables 1, 2, and 3 and Exhibit A. More generally, a person of ordinary skill in the art would understand, for example, that Whole Crop Biofuels can be differentiated from other biofuels based upon their unique mixes of products and co-products enabled by utilization of the whole crop, including agricultural residues, as indicated in associated carbon intensity measures and sustainability assessments. Such expanded product and co-product mixes can provide substantially improved sustainability performance and substantially reduced carbon intensities relative to biofuels produced with other existing or proposed production systems.

Although many of the individual component technologies required for implementing Whole Crop Biofuel Production have been developed and published, their integration into a production system capable of providing reduced carbon intensity biofuels and/or increased sustainability biofuels has not been previously disclosed, taught, or suggested. For example, WCBP has not been discussed in connection with discussion of biofuel carbon intensity reduction strategies despite the large emphasis placed on developing such strategies, for liquid fuels in general and biofuels in particular. This emphasis on carbon intensity reductions has contributed to the emergence of low carbon fuel standards in multiple jurisdictions within the U.S. and abroad as a strategy for reducing greenhouse gas emissions from liquid fuels. Such regulatory frameworks are expected to provide very strong incentives for supplying reduced carbon intensity biofuels and have generated strong opposition from industry participants that will be regulated under them. The associated controversy has brought measures of biofuel carbon intensity under intense scrutiny and has motivated substantial investment and enquiry by parties in industry, government, and academia alike into strategies for reducing the carbon intensity of biofuels. Industry has invested considerably in applying for the right to adopt reduced carbon intensity values for their biofuels on the basis of unique aspects of their production systems. Despite this high interest and expectations for strong policy incentives and high financial value, nowhere has the potential for Whole Crop Biofuels been publicly disclosed, developed, or even discussed conceptually. Moreover, none of the carbon intensity values applied for by industry based on proprietary production systems are sufficiently low to reflect Whole Crop Biofuel Production. This cannot be disregarded as a minor omission in the various venues of debate or an accidental oversight given (i) the intensity of controversy surrounding low carbon fuel standards, related initiatives to regulate fuel carbon intensity, and associated carbon intensity measures for biofuels; (ii) the expected value of developing reduced carbon intensity biofuel production systems; and (iii) the potentially dramatic reductions in biofuel carbon intensity that can be achieved via Whole Crop Biofuel Production.

It should be noted that due to the nature of agricultural, biofuel, and co-product production systems, Whole Crop Biofuel Production can be implemented at one or more facilities, at one or more locations, and/or in one or more jurisdictions owned by one or more parties. Regardless of the distribution of the production system components in these and other dimensions, Whole Crop Biofuels can be identified and differentiated from other biofuels by the greenhouse gas emissions accounting used to evaluate fuel carbon intensity and by the sustainability assessments used to evaluate sustainability performance. In particular, the LCA emissions accounting credits associated with co-products resulting from agricultural residue utilization that are attributed to the biofuel can be used to indicate utilization of Whole Crop Biofuel Production. Any biofuel with a carbon intensity measure and or sustainability assessment that reflects the unique product mixes available under Whole Crop Biofuel Production systems can be by definition a Whole Crop Biofuel and, therefore, the subject of the invention.

Agricultural production includes the production of feedstock for biofuel production by conventional or novel agriculture, silviculture, aquaculture systems, and the like. Many alternate feedstock types and feedstock production systems can be utilized in the production of Whole Crop Biofuels. Potential feedstock include, but are not limited to: corn; wheat; sugar cane; sugar beet; soybean; canola; camolina; rapeseed; jatropha; mahua; mustard; flax; sunflower; palm; hemp; field pennycress; pongamia pinnata; algae; switchgrass; miscanthus; poplar; willow; timber; or residues from biomass intensive industries. The production system can be similar to that employed in the production of conventional agriculture, silviculture, or aquaculture products and commodities or can be modified via various techniques with respect to agricultural commodity yields, agricultural residue yields, soil carbon sequestration, nutrient/fertilizer inputs, water requirements or other operational parameters or co-benefits of agricultural production systems. Such modifications can include, but are not limited to, adoption of low or no till agriculture, retention of a fraction of agricultural residues to support soil fertility, application of bio-char produced from agricultural residues or other sources, or utilization of advanced crop strains, for example.

Agricultural production in Whole Crop Biofuel production systems can be differentiated from other existing or proposed production systems in that the whole crop biomass, including agricultural residues, are utilized to enable maximization of financial and environmental benefits of the integrated biofuel production system. In other words, agricultural production in Whole Crop Biofuel Production includes utilization of both the feedstock for primary biofuel production (e.g., corn kernels, soy beans, oil seeds, sugar canes, and the like) and portions that are not destined for conversion to primary biofuels, referred to herein as agricultural residues. That being said, the proportion of whole crop biomass, including agricultural residues, removed can be less than 100%. This proportion can be varied to balance financial and environmental benefits from products and co-products, environmental performance, soil fertility, or other considerations. As such, the proportion of agricultural residue biomass removed can depend on, among other things: the production system; the crop; agricultural, silviculture, or aquaculture management practices (e.g., the extent of tillage, application of fertilizers or other soil amendments, including bio-char or biocoal produced from agricultural residues or other sources, etc.); soil conditions; other environmental factors; and other considerations. All else being equal, the proportion of residues removed can vary across locations, crops, management systems, or time, for example. Whole Crop Biofuel production can include various systems and methods for evaluating and balancing these various considerations in generalized or highly specific ways.

Residues can be removed concurrently with the harvest of primary biofuel feedstock (e.g., corn kernels, soybeans, sugar canes, canola seed, etc.) or in one or more independent processes. For example, combines or harvesters used for harvesting conventional agricultural commodities can be modified to enable simultaneous collection of agricultural residues that would otherwise be left behind or deposited in the field. Alternatively, agricultural residues can be collected with balers or arranged into windrows, processed by balers, and subsequently collected after the primary agricultural commodities are removed. Other suitable machinery and processes can also be used to enable collection and materials handling of agricultural residues. This can be accomplished all at once or in several stages to optimize costs and/or residue characteristics, including for example moisture content, dry matter yield, mineral content, etc., and/or soil characteristics including for example nutrient retention, carbon content, soil structure, erosion resistance, etc. Many variants of whole crop biomass removal are feasible.

In various embodiments, a differentiating feature of agricultural production for Whole Crop Biofuel Production is the deliberate removal and/or utilization of biomass other than that associated with the primary biofuel feedstock to support production of biofuel co-products—even if some or all of those co-products are returned to the field (e.g., in the form of bio-char as a soil amendment)—in order to reduce biofuel carbon intensity and/or improve performance against sustainability metrics.

Biofuel production can include processes by which the portion of agricultural products to be thermochemically, biochemically, or otherwise converted into biofuels—the primary biofuel feedstock—is so converted. Many variants of these processes exist, have been proposed, or can be developed. Any and all biomass to biofuel conversion technologies can be utilized within Whole Crop Biofuel Production systems. Conventional or novel biofuel conversion processes can be integrated within Whole Crop Biofuel Production systems without modification.

For example, biofuel production via fermentation (e.g., ethanol from corn, cane, wheat, beets, or cellulosic feedstock) can include among other things: all preparation and pre-treatment of the biomass to enable biochemical agents access the sugar, starch or cellulose; conversion of such biomass fractions to fermentable sugars; fermentation; biofuel purification; and all subsequent, ancillary, and downstream processes required to produce and deliver useful biofuel products. Biofuel production can include production of co-products from the biomass inputs to biofuel production (as opposed to those from agricultural residues, which are discussed below). For example, in the case of ethanol from corn kernels co-products might include wet or dry distillers' grain for use as animal feed, extractable corn oil for use as a food product, industrial chemical, for conversion into biofuel or related products, or for other uses.

As another example, in the case of lipid rich feedstock biofuel production can include among other things: lipid or vegetable oil extraction; vegetable oil conversion to biofuels via trans-esterification or various treatments with hydrogen, for example; and all subsequent, ancillary, and downstream processes required to produce and deliver useful biofuel products. In this context, biofuel production co-products include but are not limited to residues from oil extraction, which is variously referred to as oil cake or meal (as in soy meal).

These and other examples are shown in Table 1. This table is provided to indicate the breadth of biofuel production systems capable of being integrated into Whole Crop Biofuel Production. It is not intended to be exhaustive as feedstock types, conversion process, and potential products are constantly evolving and being developed.

In various embodiments, a distinguishing feature of biofuel production in Whole Crop Biofuel Production is that a portion of the biomass produced along with the primary biofuel feedstock is used to provide co-products to the primary biofuel that effectively reduce the biofuel's carbon intensity and/or improve its performance on sustainability metrics.

TABLE 1
Examples of biofuel conversion processes that can be used in connection with
Whole Crop Biofuels Production

| | Primary conversion | |
|---|---|---|
| Feedstock | processes | Potential products/co-products |
| Lipid-rich biomass, including | Vegetable extraction | Fatty Acid Methyl Esters or |
| soybean, canola, rapeseed, camolina, | followed by Trans- | “bio-diesel”; oil cake, meal, |
| palm, jatropha, mahua, mustard, | esterification | and related animal feed |
| flax, sunflower, palm oil, hemp, field | | products; glycerin and related |
| pennycress, pongamia pinnata and | | products |
| algae | Vegetable oil extraction | Substitutes for diesel, |
| | followed by various | kerosene, and related liquid |
| | potential processes | fuels; non-condensable |
| | involving hydrogen, | hydrocarbons; oil cake, meal, |
| | similar to refinery | and related animal feed |
| | hydro-treatment or | products |
| | hydrogenation | |
| Starch or sugar rich biomass, | Fermentation and | Bio-alcohols and fuels |
| including corn kernels, wheat, | related biochemical | produced from bio-alcohols; |
| sugarcane, and sugar beet | conversion processes, | food grade oils; oil-derived |
| | potentially followed by | fuels and chemicals; animal |
| | subsequent fuel | feed in the form of grain meal |
| | upgrading processes | and/or distillers grains; |
| | | cellulose-derived polymers and |
| | | chemicals; and CO₂ |
| Cellulosic feedstock including | Fermentation and | Bio-alcohols and fuels |
| switchgrass, miscanthus, other | related biochemical | produced from them; lignin |
| herbaceous energy crops, woody | conversion processes | and products produced from |
| biomass, poplar, willow, wood | | lignin; heat, power, and or |
| wastes, timber residues, mill wastes, | | electricity |
| and agricultural residues. In many | Pyrolysis | Pyrolysis oils; fuels and |
| thermochemical biofuel conversion | | chemicals produced from |
| processes these biomass feedstock | | pyrolysis oils; gaseous |
| can be mixed or co-utilized with | | hydrocarbons; fuels and |
| coal. In many of these processes, | | chemicals produced from |
| primary products or co-products can | | primary gaseous hydrocarbon |
| be used as an input to other | | products; bio-char; fuels, |
| processes to yield even more diverse | | chemicals, and products |
| final products. | | produced from bio-char; heat, |
| | | power, and or electricity |
| | Gasification and liquid | Gaseous fuels including |
| | fuel synthesis | synthetic natural gas or |
| | | hydrogen; liquid fuels |
| | | including alcohols, Fisher- |
| | | Tropsche liquids, synthetic |
| | | gasoline, naphtha, chemicals |
| | | and products from these |
| | | various intermediate products; |
| | | heat, power, and or electricity; |
| | | bio-char |
| | Hydrothermal | So called bio-crude oils; liquid |
| | upgrading | and gaseous fuels and |
| | | chemicals produced from bio- |
| | | crude and related products; |
| | | heat, power, and or electricity; |
| | | carbonized bio-solids |
| | Liquefaction | So called bio-crude oils; liquid |
| | | and gaseous fuels and |
| | | chemicals produced from bio- |
| | | crude oils; ammonia; CO₂; and |
| | | heat, power, and or electricity |
| | Anaerobic bio- | Methane; liquid and gaseous |
| | digestion | fuels and chemicals produced |
| | | from methane; CO₂; heat, |
| | | power, and or electricity |

Agricultural residue utilization can include processes, systems, and methods that use as process inputs agricultural residues resulting as a consequence of primary biofuel feedstock production. The use of these agricultural residues improves the lifecycle environmental performance of associated biofuel production systems. This improved environmental performance can be credited to the biofuels and thereby reduce the carbon intensity of the biofuel, improve its performance on sustainability metrics, enable generation of additional tradable credits, and/or qualify the biofuel with respect to other environmental standards, including sustainability standards.

In various embodiment, a differentiating feature of agricultural residue utilization in the context of Whole Crop Biofuels is that the linkage for emissions accounting or other purposes between this biomass (e.g., the agricultural residues) and its products on the one hand and the primary biofuel on the other is via the production of the primary feedstock for biofuel production (rather than via primary biofuel feedstock pre-treatment and processing into biofuel products). While, biofuel production systems can conceivably incorporate agricultural residues utilization within the biofuel production process, such utilization does not exclude this biomass from the definition of agricultural residue.

Utilization of agricultural residues for biofuel production does not necessarily imply Whole Crop Biofuel Production. Rather Whole Crop Biofuel Production can be differentiated from other production processes by the utilization of one portion of a biomass feedstock for biofuel production and another portion of the biomass feedstock for some another purpose that enables the use, application, or assignment of reduced biofuel carbon intensities or improved biofuel performance against sustainability metrics (e.g., mitigates anthropogenic greenhouse gas emissions and associates the mitigation to a biofuel in a context of a regulatory framework).

Note that several potential uses for agricultural residues within Whole Crop Biofuel Production can also yield secondary biofuels, but by a different process from the primary biofuel. For example a production system including ethanol production from corn kernels and ethanol production from corn stover represents a Whole Crop Biofuel Production system because the two portions of the corn crop (e.g., kernels and stover) are processed by distinct technologies (e.g., conventional starch-to-ethanol and emerging cellulosic ethanol technologies, respectively) to yield a primary biofuel (e.g., ethanol from corn kernels) with a reduced carbon intensity relative to ethanol produced without use of the agricultural residues resulting from production of the primary biofuel feedstock (corn kernels).

In the case of first generation biofuels, agricultural residues can include but are not limited to stalks, stems, leaves, cobs, straw, pods, shells or other biomass that is not processed further in biofuels production. This residue might traditionally be used or disposed of in a variety of ways including but not limited to being: burned in the field or in piles or other aggregations; left in the field to rot or support soil structure, fertility, or erosion control; or used as fodder or bedding in animal husbandry. In Whole Crop Biofuels Production, some fraction of these residues can be used to supply one or more additional products or services including, for example: building or construction materials; pulp or paper products; energy products (e.g., heat, power, electricity, liquid fuels, gaseous fuels, solid fuels, etc.) produced using one or more different technologies (e.g., combustion, gasification, liquefaction, liquid fuels synthesis, fermentation, anaerobic digestion, pyrolysis, torrefaction, hydrothermal treatment, hydrothermal upgrading, etc.); gaseous, liquid, and/or solid fuels or chemicals; secondary products produced from the gaseous, liquid, or solid fuel or chemical products (e.g., paints, dyes, polymers, adhesives, lubricants, organic acids, etc.); bio-char, bio-coal or other bio-solids; soil amendments and fertilizers; animal feeds; CO₂ for enhanced oil recovery or sequestration away from the atmosphere; and/or biomass carbon for sequestration by other means (including solid phase biomass carbon sequestration). Due to their origin in biomass from within the biofuel supply chain, these products can be viewed as co-products of the primary biofuel for the purposes of lifecycle assessment of carbon intensity and sustainability performance.

As noted above, some proportion of agricultural residues might be effectively utilized in the agricultural production system by being retained on the field in its raw form or by being returned to the field in a modified form (e.g., as bio-char or another bio-solid resulting from various processes). This proportion of agricultural residues can, but does not necessarily, result in LCA emissions accounting credits in carbon intensity measures, depending on the carbon intensity evaluation methodology. As the proportion retained in the field in its raw form can be highly variable across time, location, crop, management practice and/or other dimensions, this use can on some occasions and in some circumstances be applied to 100% of agricultural residues. This does not preclude associated biofuels from being defined as Whole Crop Biofuels, so long as on at least some occasions and/or in some circumstances the proportion of residues left in the field in its raw form is less than 100%. Note that the term “field” is used to refer to the production environment, whether or not it is manifest as a field in the conventional agricultural sense of the word.

An important feature of these co-products (either those returned to the field as a soil amendment for example, those exported, or both) within Whole Crop Biofuel Production systems is that their use—individually or in some combination—provides emissions or sustainability benefit(s) that can be attributed to the biofuel within one or more measures of carbon intensity or sustainability performance.

Several examples of agricultural residue utilization systems suitable for integration with alternate primary biofuel feedstock to enable Whole Crop Biofuel Production are indicated in Table 2. Note that this table is not intended to be exhaustive as the primary biofuel feedstock, agricultural residue definition, and particularly residue utilization technologies and products mixes are constantly evolving. The absence of particular feedstock, residues, or utilization technologies from this table does not imply that they are excluded from the applicability or definition of Whole Crop Biofuel Production.

TABLE 2
Examples of agricultural residue utilization for alternate primary biofuel feedstock.

| | | | Potential residue-derived |
|---|---|---|---|
| Biofuel feedstock | Agricultural residue | Utilization technology | biofuel co-products |
| Agricultural | Stalks, stems, | Combustion; | building or construction |
| products including | leaves, cobs, “corn | gasification; integrated | materials; pulp or paper |
| corn kernels, | stover”, “cane | gasification combined | products; heat, power, |
| wheat, sugarcane, | trash”, husks, shells, | cycle power generation; | and or electricity; |
| and sugar beet, | pods and other | cellulosic biofuel | gaseous, liquid, or solid |
| soybean, canola, | biomass not | production technologies | fuels or chemicals; |
| rapeseed, | specifically rich in | (see Table 1); | secondary products |
| camolina, | starches, sugars, or | carbonization; | produced from the |
| mustard, flax, | lipids and typically | torrefaction; hydro- | gaseous, liquid, or solid |
| sunflower, palm | separated from the | thermal treatment; | fuel or chemical products; |
| oil, hemp, field | biofuel feedstock | enzymatic hydrolysis; | bio-char, bio-coal or |
| pennycress | before conversion to | anaerobic digestion; | related bio-solids; soil |
| | biofuels | composting; solid phase | amendments and |
| Oil seeds from | Leaves, trimmings, | biomass carbon storage | fertilizers; animal feeds, |
| trees or woody | shells, pods, husks | | CO₂ for enhanced oil |
| shrubs | and other available | | recovery or sequestration; |
| | biomass not | | biomass carbon for |
| | specifically rich in | | sequestration by other |
| | lipids, not suitable | | means (including solid |
| | for transport to | | phase biomass carbon |
| | conversion facilities | | sequestration) |
| | or biofuel | | |
| | conversion to lipid- | | |
| | derived biofuels, or | | |
| | otherwise diverted | | |
| | from biofuels | | |
| | production | | |
| Cellulosic | Leaves, branches, | | |
| biomass | and other biomass | | |
| | that is deemed | | |
| | unsuitable for | | |
| | biofuel production, | | |
| | unsuitable for | | |
| | transport to biofuel | | |
| | production facilities, | | |
| | or is otherwise | | |
| | diverted from | | |
| | biofuel production | | |
| Aquaculture | Algae residues not | | |
| biomass | suitable for | | |
| | conversion to | | |
| | biofuels | | |

Emissions accounting and/or sustainability assessment systems can include any one or more systems that enable emissions and sustainability benefits of using the whole crop biomass to be attributed to the biofuel product to enhance the value of that biofuel and or to generate tradable credits that can be marketed along with or independently from the biofuel product. These systems can take any number of forms, depending critically on regulatory and or market requirements and opportunities. Many such systems exist, are being developed, or have been conceived, including for example the California modified GREET model, GHGenius, EPA's consequential LCA modeling framework developed in the context of the federal Renewable Fuel Standard (RFS2), the Gabi Software tool, the SimaPro software tool, the EcoInvent Database, among others.

The emissions accounting and/or sustainability assessments or assessment systems for Whole Crop Biofuel Production can be differentiated from those used to describe or evaluate other production systems by the LCA accounting credits assigned or other accounting provided for the mixes of products and co-products unique to Whole Crop Biofuel Production. These mixes are further elaborated in text above, in Tables 1-3, in FIG. 2C (using the example of ethanol production from corn), and in Exhibit A.

Because Whole Crop Biofuel Production can be implemented in many ways by one or more parties in one or more countries or jurisdictions, the emissions accounting and/or sustainability assessment system represents a key mechanism for identifying and differentiating Whole Crop Biofuel Production from other production systems and Whole Crop Biofuels from other biofuels. This is because it provides an integrated record of the products, co-products, and associated production system used for any given biofuel product. In particular, the emissions accounting and/or sustainability assessment of Whole Crop Biofuels can include some type of credit for the product mixes resulting from use of the whole crop biomass, including agricultural residues. Therefore, any biofuel produced and documented with an emissions accounting and/or sustainability assessment system that reflects a product and co-product mix consistent with Whole Crop Biofuel Production can be identified and defined as a Whole Crop Biofuel.

Several examples of components that might be included in emissions accounting and/or sustainability assessments of Whole Crop Biofuel Production systems are indicated in Table 3. This table is not intended to be exhaustive as the set of primary biofuel products, co-products from primary biofuel processing, and potential co-products from agricultural residue processing are constantly evolving. The absence of any particular primary product, processing co-product, residue-derived co-product, or combination thereof does not imply that such product, co-product, or combination is not an example of Whole Crop Biofuel Production.

TABLE 3
Example product mixes and components reportable within emissions
accounting and/or sustainability assessments of Whole Crop Biofuels and
Whole Crop Biofuel Production systems.

| | Co-products from | Co-products from |
|---|---|---|
| Primary biofuel product | primary biofuel processing | agricultural residue processing |
| Corn (including maize) | Any combination of animal feed | building or construction material; |
| alcohols (including | (e.g., distillers grains), products | pulp or paper substitute; heat, |
| ethanol, butanol, etc.), | for human consumption (e.g., | power, and or electricity; |
| or fuels derived by | edible oils), biofuels or chemicals | gaseous, liquid, or solid fuels or |
| upgrading corn-derived | derived from extracted oils (e.g., | chemicals; secondary products |
| alcohols. | bio-diesel, or petroleum | produced from the gaseous, |
| | substitutes produced via hydro- | liquid, or solid fuel or chemical |
| | treatment), and other co-products | products; bio-char, bio-coal or |
| | from corn kernel fractions not | related bio-solids; soil |
| | directly converted to biofuel. | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |
| Sugar cane alcohols | Any combination of products for | building or construction material; |
| (including ethanol, | animal or human consumption | pulp or paper substitute; heat, |
| butanol, etc.), or fuels | (e.g., sugar, molasses, etc.), | power, and or electricity; |
| derived by upgrading | bagasse-derived heat and power | gaseous, liquid, or solid fuels or |
| cane alcohols. | (including electricity), bagasse- | chemicals; secondary products |
| | derived solid phase biomass | produced from the gaseous, |
| | carbon storage, other co-products | liquid, or solid fuel or chemical |
| | derived from cane fractions not | products; bio-char, bio-coal or |
| | directly converted to biofuel | related bio-solids; soil |
| | | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |
| Wheat alcohols | Any combination of products for | building or construction material; |
| (including ethanol, | animal or human consumption, | pulp or paper substitute; heat, |
| butanol, etc.), or fuels | processing residue derived heat | power, and or electricity; |
| derived by upgrading | and power (including electricity), | gaseous, liquid, or solid fuels or |
| wheat alcohols. | other co-products derived from | chemicals; secondary products |
| | wheat fractions not directly | produced from the gaseous, |
| | converted to biofuel | liquid, or solid fuel or chemical |
| | | products; bio-char, bio-coal or |
| | | related bio-solids; soil |
| | | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |
| Sugar beet alcohols | Any combination of products for | building or construction material; |
| (including ethanol, | animal or human consumption, | pulp or paper substitute; heat, |
| butanol, etc.), or fuels | processing residue derived heat | power, and or electricity; |
| derived by upgrading | and power (including electricity), | gaseous, liquid, or solid fuels or |
| beet alcohols. | other co-products derived from | chemicals; secondary products |
| | sugar beet fractions not directly | produced from the gaseous, |
| | converted to biofuel | liquid, or solid fuel or chemical |
| | | products; bio-char, bio-coal or |
| | | related bio-solids; soil |
| | | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |
| Soy biodiesel and other | Any combination of products for | building or construction material; |
| petroleum substitutes | animal or human consumption | pulp or paper substitute; heat, |
| derived from soy oils. | (including edible oils, soy meal, | power, and or electricity; |
| | oil cake, etc.), other co-products | gaseous, liquid, or solid fuels or |
| | derived from soy beans not | chemicals; secondary products |
| | directly converted to biofuel | produced from the gaseous, |
| | | liquid, or solid fuel or chemical |
| | | products; bio-char, bio-coal or |
| | | related bio-solids; soil |
| | | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |
| biodiesel and other | Any combination of products for | building or construction material; |
| petroleum substitutes | animal or human consumption | pulp or paper substitute; heat, |
| derived from canola, | (including edible oils, soy meal, | power, and or electricity; |
| camolina, rapeseed, | oil cake, etc.), other co-products | gaseous, liquid, or solid fuels or |
| mustard, flax, | derived from oilseed not directly | chemicals; secondary products |
| sunflower, safflower, | converted to biofuel | produced from the gaseous, |
| hemp, palm, jatropha, | | liquid, or solid fuel or chemical |
| field pennycress, | | products; bio-char, bio-coal or |
| mahua, pangamia | | related bio-solids; soil |
| pinnata, or other oilseed | | amendments and fertilizers; |
| crops | | animal feeds; CO₂ for enhanced |
| | | oil recovery or sequestration; |
| | | biomass carbon for sequestration |
| | | by other means (including solid |
| | | phase biomass carbon |
| | | sequestration) |
| Cellulosic biofuel | Any combination of the following | building or construction material; |
| | produced as a co-product of the | pulp or paper substitute; heat, |
| | biomass processed in the facility | power, and or electricity; |
| | or by the process producing the | gaseous, liquid, or solid fuels or |
| | primary biofuel product: Heat, | chemicals; secondary products |
| | power, and or electricity; | produced from the gaseous, |
| | gaseous, liquid, or solid fuels or | liquid, or solid fuel or chemical |
| | chemicals; products produced | products; bio-char, bio-coal or |
| | from gaseous, liquid, or solid fuel | related bio-solids; soil |
| | or chemical products; bio-char, | amendments and fertilizers; |
| | bio-coal or related bio-solids; | animal feeds; CO₂ for enhanced |
| | soil amendments and fertilizers; | oil recovery or sequestration; |
| | animal feeds, CO₂ for enhanced | biomass carbon for sequestration |
| | oil recovery or sequestration; | by other means (including solid |
| | biomass carbon for sequestration | phase biomass carbon |
| | by other means (including solid | sequestration) |
| | phase biomass carbon | |
| | sequestration) | |
| Algal biofuel | | building or construction material; |
| | | pulp or paper substitute; heat, |
| | | power, and or electricity; |
| | | gaseous, liquid, or solid fuels or |
| | | chemicals; secondary products |
| | | produced from the gaseous, |
| | | liquid, or solid fuel or chemical |
| | | products; bio-char, bio-coal or |
| | | related bio-solids; soil |
| | | amendments and fertilizers; |
| | | animal feeds; CO₂ for enhanced |
| | | oil recovery or sequestration; |
| | | biomass carbon for sequestration |
| | | by other means (including solid |
| | | phase biomass carbon |
| | | sequestration) |

Additional examples of key system components in sample Whole Crop Biofuel Production Systems are provided in Exhibit A.

### EXAMPLES

### Methods of Engineering a Biofuel Cycle and Accounting for Carbon Flows and Determining a Regulatory Value for a Biofuel

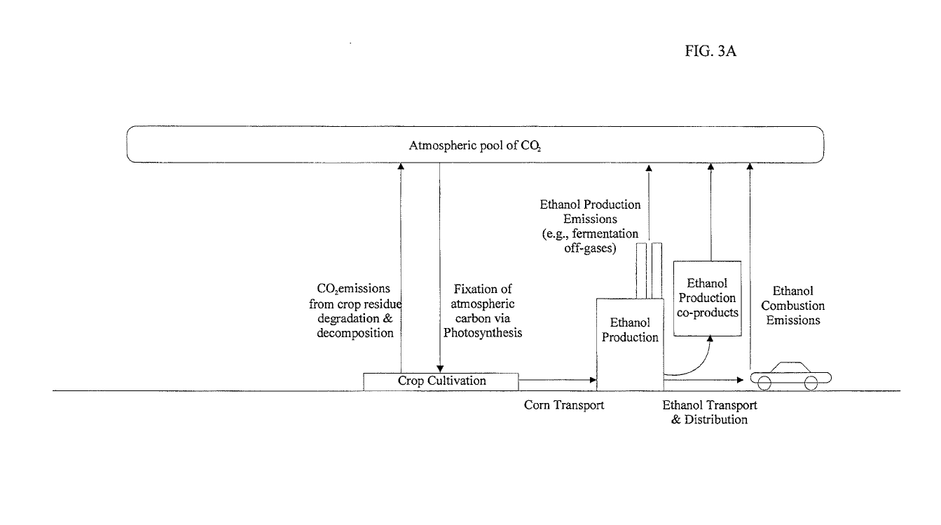

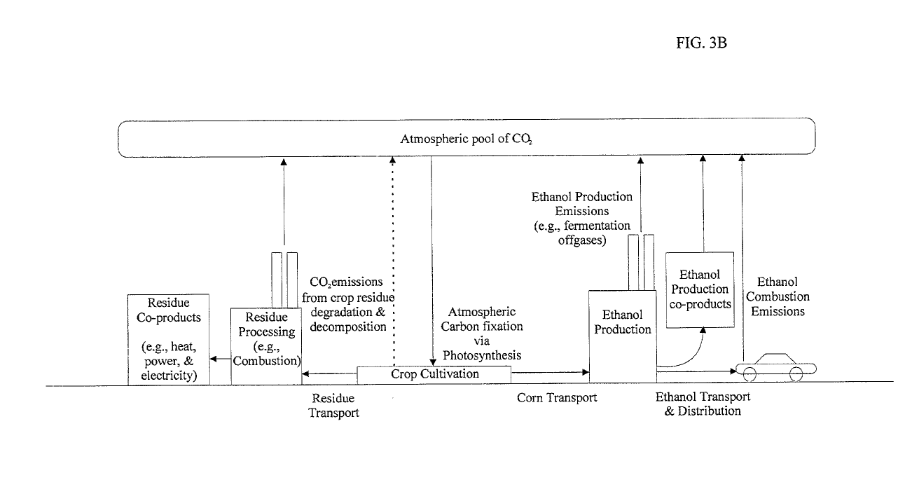

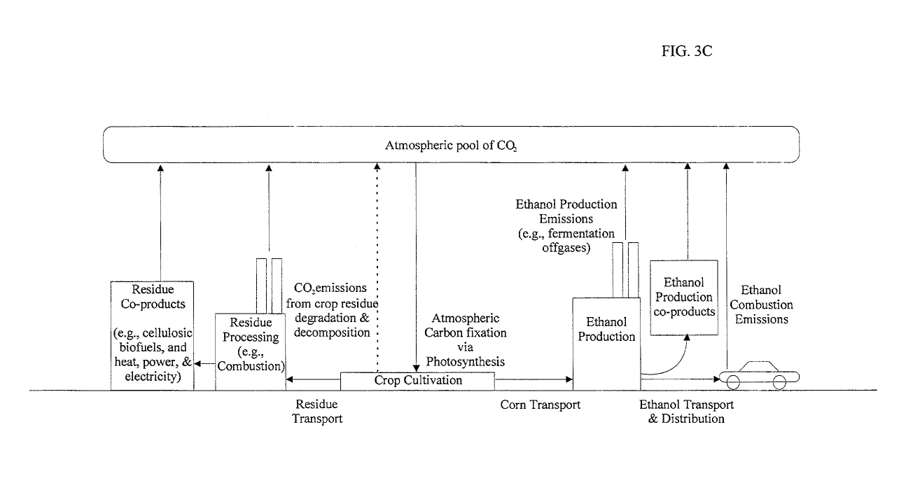

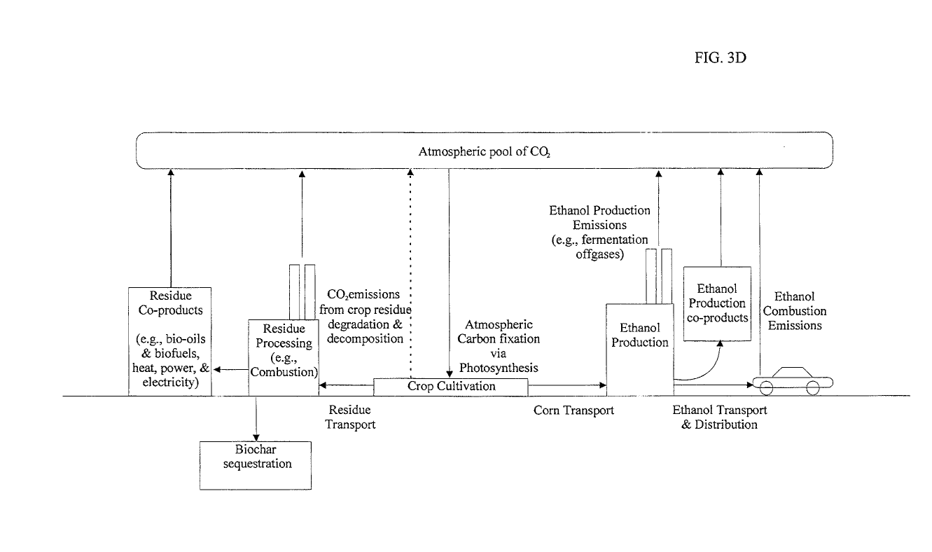

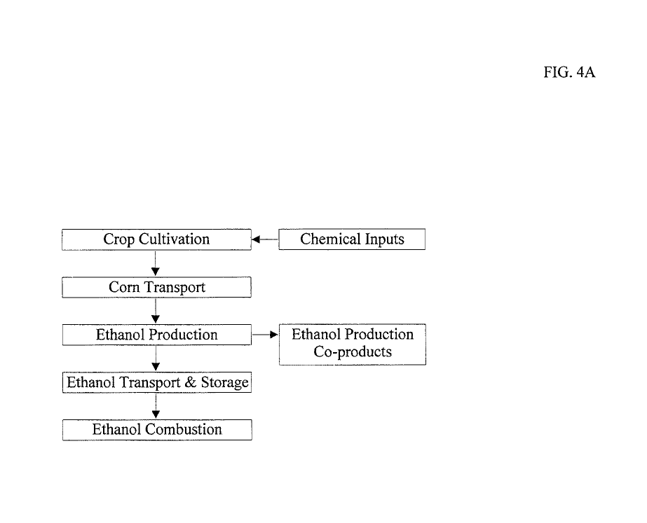

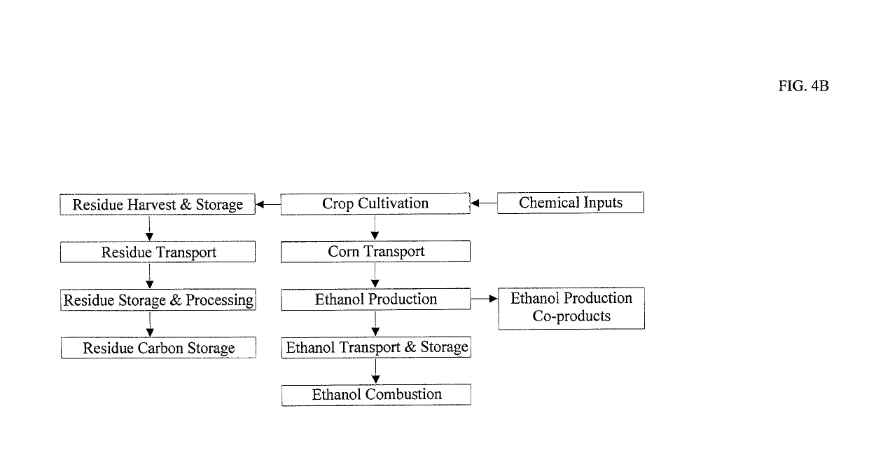

FIG. 3A shows biogenic carbon flows in an example of conventional corn ethanol production and use. FIG. 3A is useful comparison for FIGS. 3B-3D, which illustrate examples of engineering a carbon cycle in the context of WCBP to mitigate anthropogenic greenhouse gas emissions. FIGS. 3A-D also illustrates examples of carbon cycle components that can be used in determining a regulatory value that accounts for the carbon intensity and/or sustainability of a biofuel. The following examples can be mapped onto the process schematics shown in FIG. 4 and algorithms discussed in connection with Tables 4-8, and analyzed to determine a regulatory value for a biofuel. These examples, together with the disclosure, also provide a framework and useful examples for applying the invention in the context of additional and/or future regulatory frameworks.

The carbon cycle shown in FIG. 3A can be considered to begin when biogenic carbon is fixed from the atmosphere via photosynthesis. The portion of the fixed carbon embodied in primary biofuel feedstock (e.g., corn kernels) is transported to an ethanol production facility. Separately, the portion of the fixed carbon embodied in agricultural residues is subject to natural degradation and decomposition, through which it is returned to the atmosphere. Ethanol is produced at the production facility from the primary biofuel feedstock. A portion of primary biofuel feedstock carbon is released to the atmosphere during ethanol production (e.g., via fermentation off-gases), while the balance is converted into biofuel (e.g., ethanol) and biofuel production co-products (e.g., animal feed, vegetable oils, and/or biodiesel). Then, the ethanol and ethanol production co-product(s) are used, and the biogenic carbon in the biofuel and biofuel production co-products is returned to the atmosphere. In some cases this return of biogenic carbon to the atmosphere can be direct (e.g., in the case of biofuel combustion) or indirect (e.g., in the case of animal feed co-product use).

Note that the figures focus on biogenic carbon flows in order to illustrate a principle of WCBP. However, other flows of greenhouse gases are relevant to the biofuel carbon cycle and accounting for carbon flows and determining a regulatory value for a biofuel. For example, while regulatory values can be calculated solely from biogenic carbon flows, in many cases a consideration of carbon flows from fossil hydrocarbon sources (e.g., petroleum, coal, and the like) can be important in calculating a regulatory value. Examples of other relevant flows are discussed in connection with Tables 4-9.

### Example 1

### Combustion

FIG. 3B shows biogenic carbon flows in an example of WCBP of corn ethanol, where the carbon cycle is engineered to include residue processing by combustion. Combustion of an agricultural residue can substitute for combustion of a fossil hydrocarbon product, thereby preventing carbon from a fossil hydrocarbon product from flowing to the atmosphere. For example, the production and use of the co-product can include producing electricity from a combination of agricultural residue and coal, thereby reducing coal use and reducing the amount of carbon from coal that is released into the atmosphere.

In FIG. 3B, the fixing of biogenic carbon from the atmosphere, as well as the production and use of ethanol can be essentially the same as shown and described in connection with FIG. 3A. A second fraction of the agricultural biomass (e.g., comprising agricultural residue), which embodies biogenic carbon, is transported for processing into co-product (e.g., heat, power, electricity, and the like). The co-product generates LCA emission accounting credits. In this example, processing releases the biogenic carbon to the atmosphere. However, because the carbon in the biofuel is biogenic, the net greenhouse gas emission is zero. Nevertheless, anthropogenic greenhouse gas emissions are mitigated by WCBP because the use of a fossil hydrocarbon product (e.g., coal) is replaced by use of the second fraction of the agricultural biomass (e.g., agricultural residue burned in a coal-fired electric plant). Other examples of WCBP may not involve the same degree of contemporaneous release of biogenic carbon to the atmosphere (e.g., where the co-product is not contemporaneously combusted or decomposed, e.g., where a co-product is bio-char, bio-chemical, bio-plastic, building material, construction material, paper pulp, and the like).

Optionally (e.g., shown as a dashed line from crop cultivation to the atmospheric pool of CO₂) biomass, for example some of the agricultural residue, can be left in the field to support soil fertility, protect against erosion, and/or achieve other agricultural objectives. Such biomass is subject to natural degradation and decomposition, through which the embodied biogenic carbon is returned to the atmosphere. This flow is indicated with a dashed line to reflect its secondary impact in differentiating net carbon flows relative to those indicated in FIG. 3A. Note that in this example, the arrow connecting Residue Processing to Co-products of Residue Processing represents an energy flow, not a carbon flow. Also note that Residue Processing (as well as any of the other function represented by arrows or boxes in any of the embodiments or examples) can be implemented in multiple steps.

### Example 2

### Cellulosic Biofuel

FIG. 3C shows biogenic carbon flows in an example of WCBP of corn ethanol, where the carbon cycle is engineered to include the production of a cellulosic biofuel as a co-product. Combustion of such a biofuel co-product can substitute for combustion of a fossil hydrocarbon product, thereby preventing carbon from a fossil hydrocarbon product from flowing to the atmosphere.

In FIG. 3C, the fixing of biogenic carbon from the atmosphere, as well as the production and use of ethanol can be essentially the same as shown and described in connection with FIG. 3A. A second fraction of the agricultural biomass (e.g., comprising agricultural residue), which embodies biogenic carbon, is transported for processing into co-product (e.g., cellulosic biofuel, heat, power, electricity, and the like). The co-product generates emission accounting credits and mitigates anthropogenic greenhouse gas emission. In this example, processing and use releases the biogenic carbon to the atmosphere, for example, through the combustion of the cellulosic biofuel and the production of any heat, power, and/or electricity. As described in connection with FIG. 3B, biomass can optionally be left in the field to support soil fertility, protect against erosion, and/or achieve other agricultural objectives.

### Example 3

### Pyrolysis

FIG. 3D shows biogenic carbon flows in an example of WCBP of corn ethanol, where the carbon cycle is engineered to include co-product production by pyrolysis. Combustion of a pyrolysis co-product (e.g., bio-oil or a bio-oil product) can substitute for combustion of a fossil hydrocarbon product, thereby preventing carbon from a fossil hydrocarbon product from flowing to the atmosphere. Sequestration of a pyrolysis co-product (e.g., biochar) can also prevent net carbon flow to the atmosphere on an environmentally relevant timescale.

In FIG. 3D, the fixing of biogenic carbon from the atmosphere, as well as the production and use of ethanol can be essentially the same as shown and described in connection with FIG. 3A. A second fraction of the agricultural biomass (e.g., comprising agricultural residue), which embodies biogenic carbon, is transported for processing via pyrolysis into co-product(s) (e.g., biochar, bio-oils, solid biofuels, liquid biofuels, gaseous biofuels, heat, power, electricity, and the like). The pyrolysis co-product(s) generates emission accounting credits and mitigate the release of carbon into the atmosphere. In this example, processing and use releases the biogenic carbon to the atmosphere, for example, through the combustion of co-product(s) and the production of any heat, power, and/or electricity. However, biogenic carbon is not necessarily released contemporaneously into the atmosphere. For example, biochar can be sequestered away from the atmosphere for time scales relevant to climate policy objectives. In some embodiments, biochar can be used as a solid fuel. As described in connection with FIG. 3B, biomass can optionally be left in the field to support soil fertility, protect against erosion, or achieve other agricultural objectives.

### Example 4

### Process Schematics for Lifecycle Emissions Accounting

The components of a WCBP carbon cycle can be represented as process schematics. Such schematics can facilitate the conceptualization and/or mapping of a biofuel carbon cycle (e.g., including a fuel pathway) to an accounting system. In this example FIG. 4A shows a process schematic for lifecycle emissions accounting (e.g., related to FIG. 3A and Table 4) and FIG. 4B shows a process schematic for lifecycle emissions accounting for WCBP corn ethanol, where a co-product is electricity (e.g., related to FIG. 3B and Tables 5-8).

The schematic in FIG. 4A is adapted from FIG. 1 of the California Air Resources Board “Detailed California-Modified GREET Pathway for Corn Ethanol,” which describes the lifecycle components used to define the lifecycle greenhouse gas emissions from corn ethanol production and to define the regulatory default value of carbon intensity to be applied to corn ethanol fuels under the California Low Carbon Fuel Standard. Such regulatory default values provide a baseline for a particular biofuel (e.g., ethanol with a carbon intensity=x). Entities would then have an environmental and economic incentive to engineer and/or characterize a biofuel carbon cycle that results in a biofuel with a more favorable regulatory value (e.g., ethanol with a carbon intensity <x, though the relationship may vary depending upon the metric of sustainability/CI and accounting convention).

FIG. 4B shows an example process schematic for lifecycle emissions accounting for WCBP corn ethanol, where a co-product is electricity. This schematic illustrates lifecycle components used to describe the lifecycle greenhouse gas emissions from WCBP corn ethanol. One difference between this schematic and FIG. 4A is the column of lifecycle components on the left side of the figure, which describe processes associated with harvest, transport, and utilization of crop residues for the production of electricity. Note that FIGS. 4A and 4B provide one convenient format for illustrating these lifecycle components, which can be alternatively illustrated with greater or fewer lifecycle components. Other formats are conceivable and would likely be required in other regulatory contexts. A person with ordinary skill in the art can adapt the present examples to other formats for illustrating, conceptualizing, and quantifying the lifecycle components and emissions from SPBCS. Such adaptations are included in SPBCS.

One feature of various embodiments of WCBP is the inclusion of components describing the utilization of agricultural residues that are produced as a consequence of biofuel feedstock cultivation (crop cultivation in the present example), for purposes that generate emissions accounting credits within the biofuel lifecycle greenhouse gas emissions accounting schematic. No incentives existed for SPBCS, or the concept of developing new sources of emission accounting credits, before the emergence of regulatory frameworks such as the EU-ETS and no incentives existed for developing new sources of emissions accounting credits within fuel supply chains before fuel-specific regulatory frameworks including: U.S. RFS2; LCFS currently implemented in CA and BC, and being contemplated for WA, OR, and NEMA regions; EU-RED and FQD; and UK-RTFO.

Given a biofuel or biofuel carbon cycle, there are a number of ways to account for carbon flows and determine a regulatory value for the biofuel. In jurisdictions having an established regulatory system, a person of ordinary skill in the art would understand that they can first look to the established regulatory system for guidance in determining an applicable methodology. However, it is also understood that such systems are generally based upon quantifying relevant components of the biofuel carbon cycle and accounting for the relevant components to arrive at a net carbon intensity and/or sustainability measure for the biofuel.

The quantification of relevant carbon cycle components can be in terms of units of greenhouse gas per units of energy (e.g., gCO₂/MJ). The accounting methodology can be, for example, system expansion or allocation. In system expansion, emissions accounting credits are provided for net emissions reductions associated with use of the various products as a substitute for more conventional products (see, e.g., Examples 6 and 7). Under allocation methodologies, a fraction of lifecycle emissions (generally emissions associated with processes upstream of the material diversion for co-product use) are allocated to the various products (see, e.g., Examples 8 and 9).

### Example 5

### Greenhouse Gas Emissions Summary for Corn Ethanol (Baseline)

Table 4 shows a greenhouse gas emission (GHG) accounting summary for dry and wet mill corn ethanol. This summary serves as a baseline for the WCBP examples shown in Table 5-8. This summary is adapted from the California Air Resources Board 2009 “Detailed California-Modified GREET Pathway for Corn Ethanol,” where the derivation of the values is provided in detail.

TABLE 4

| Corn Ethanol Fuel | Dry Mill Process | Wet Mill Process |
|---|---|---|
| Cycle Components | GHG (gCO₂/MJ) | GHG (gCO₂/MJ) |
| Well-to-tank | | |
| Crop Cultivation | 5.65 | 5.81 |
| Chemical Inputs to Cultivation | 30.2 | 31.35 |
| Corn Transportation | 2.22 | 2.28 |
| Ethanol Production | 38.3 | 48.78 |
| Ethanol Transport & Storage | 2.7 | 2.63 |
| Ethanol Production Co-products | −11.51 | −16.65 |
| Total well-to-tank | 67.6 | 74.2 |
| Tank-to-wheel | | |
| Ethanol Combustion | 0 | 0 |
| Total tank-to-wheel | 0 | 0 |
| Total well-to-wheel | 67.6 | 74.2 |

In this example, the regulatory value for dry mill corn ethanol is 67.6 gCO₂/MJ and the regulatory value for wet mill corn ethanol is 74.2 gCO₂/MJ. The accounting shown in Table 4 (as well as Table 5-8) reflects direct emissions only. Additional emissions factors for indirect emissions (e.g., indirect land use change) can also be included within an accounting framework, as can other combinations of direct emissions. For example, additional emissions factors or other accounting may also be included to represent increased fertilizer requirements to compensate for nutrients removed with agricultural residues. In examples 5-9, the Ethanol Combustion values assume all carbon in the fuel itself is biogenic and therefore do not represent a net emission to the atmosphere.

### Example 6

### GHG Summary for Corn Ethanol (WCBP, Electricity Co-Product, System Expansion Methodology)

Table 5 shows a greenhouse gas emissions summary for dry and wet mill corn ethanol for a WCBP process where electricity is a co-product under a system expansion methodology.

TABLE 5

| Corn Ethanol Fuel | Dry Mill Process | Wet Mill Process |
|---|---|---|
| Cycle Components | GHG (gCO₂/MJ) | GHG (gCO₂/MJ) |
| Well-to-tank | | |
| Crop Cultivation | 5.65 | 5.81 |
| Chemical Inputs to Cultivation | 30.2 | 31.35 |
| Corn Transportation | 2.22 | 2.28 |
| Ethanol Production | 38.3 | 48.78 |
| Ethanol Transport & Storage | 2.7 | 2.63 |
| Ethanol Production Co-products | −11.51 | −16.65 |
| Residue Harvest & Storage | 1.70 | 1.74 |
| Residue Transportation | 2.22 | 2.28 |
| Electricity production | 0 | 0 |
| Electricity utilization/substitution | −68.8 | −66.3 |
| Total well-to-tank | 2.7 | 12.0 |
| Tank-to-wheel | | |
| Carbon in fuel | 0 | 0 |
| Total tank-to-wheel | 0 | 0 |
| Total well-to-wheel | 2.7 | 12.0 |

In this example, the regulatory value for dry mill corn ethanol is 2.7 gCO₂/MJ and the regulatory value for wet mill corn ethanol is 12.0 gCO₂/MJ. In comparison to Example 5, the electricity co-product provides a significant benefit in terms of providing the corn ethanol with a more favorable regulatory value than the baseline. Thus, the environmental and accounting value of the co-product is large (e.g., dominates the calculation of the regulatory value) and the environmental and accounting cost of co-product production is small (e.g., less than that of biofuel production and little effect on the regulatory value).

In this Example, the Residue Harvest & Storage value assumes that residue harvest requires 30% of the energy required (yielding 30% of the GHG emissions) for crop cultivation (e.g., corn farming) and has zero storage losses. The Residue Transportation value assumes that transportation emissions are equal to those for transporting the corn, based on 1:1 mass ratio (see below). However, emissions can be substantially higher (e.g., due to substantially lower density of stover, which can be mitigated by processing the agricultural residue) as well as differences in transportation mode (e.g., vehicle type, distance, and the like) and/or distance (in the case that biofuel and residue processing facilities are not co-located). The Electricity production value assumes that all carbon emitted is biogenic and does not represent a net emission to the atmosphere. The Electricity utilization/substitution value assumes the substitution of residue-generated electricity for electricity generated from coal. The derivation of the Electricity utilization/substitution value is shown in Example 7. Such variables, as well as other modification or variations to a WCBP system, are readily accounted for by measuring or calculating the emissions/carbon intensity/sustainability of the system components.

### Example 7

### Computational Algorithm for Defining Emissions Accounting Credits Applied in the Context of the California Low Carbon Fuel Standard (WCBP, Electricity Co-Product, System Expansion Methodology).

Table 6 shows an example of computational algorithm for defining emissions accounting credits produced by WCBP applied in the context of the California Low Carbon Fuel Standard (electricity co-product, system expansion methodology). The Carbon intensity of displaced electricity value reflects a direct substitution for electricity generation from coal (i.e., in this example, the residue is assumed to be co-fire in a coal fired power plant. Other values can be appropriate in other circumstances such as substitution for grid average electricity). The Electricity utilization/substitution values shown in Table 5 were calculated according to the following methodology.

TABLE 6

| | | | |
|---|---|---|---|
| | Dry Mill | Wet Mill | |
| Parameter | Process | Process | Units |

Assumptions

| | | | |
|---|---|---|---|
| Stover:kernal mass ratio | 1 | 1 | kg(stover)/ |
| | | | kg(kernel) |
| Fraction of stover removed | 0.5 | 0.5 | |
| Corn kernel mass (dry) | 21.5 | 21.5 | kg/bu |
| Corn ethanol yield | 2.62 | 2.72 | gal/bu |
| Ethanol heat content | 76330 | 76330 | btu/gal |
| Stover heat content | 15 | 15 | MJ/kg |
| Electricity conversion efficiency | 0.3 | 0.3 | MJ(electricity)/ |
| | | | MJ(stover) |
| Carbon intensity of displaced | 300 | 300 | gCO₂/MJ |
| electricity | | | (electricity |
| | | | displaced) |
| Energy unit conversion factor | 947.8 | 947.8 | btu/MJ |

Algorithm output

| | | | |
|---|---|---|---|
| Carbon intensity reduction from | 68.8 | 66.3 | gCO₂/MJ(eth) |
| WCBP | | | |

In this example, the reduction in regulatory value for dry mill corn ethanol is 68.8 gCO₂/MJ and the reduction in regulatory value for wet mill corn ethanol is 66.3 gCO₂/MJ. These values are used in Example 6.

In Example 7, the Assumptions are defined as follows: Stover:kernel mass ratio defines the ratio of corn stover yield to corn kernel yield on a dry mass basis; Fraction of stover removed defines the fraction of corn stover removed from the field, with the remainder assumed to be left in place to advance erosion protection, soil fertility, and other agricultural objectives; Corn kernel mass (dry) defines the mass of a bushel of corn kernels; Corn ethanol yield defines the ethanol produced per bushel of corn kernels; Ethanol heat content defines the heating value of anhydrous ethanol produced—a lower heating value is used here to be consistent with the standard applied under the California Low Carbon Fuel Standard; Stover heat content defines the heating value of stover removed from the field—this can be defined on either a higher heating value or lower heating value basis, so long as the corresponding electricity conversion efficiency is used; Electricity conversion efficiency defines the power plant-specific net energy efficiency of converting stover to electricity—this can be defined on either a higher heating value or lower heating value basis, so long as the corresponding stover heat content is used—in the case of stover co-fire with coal in a coal-fired power plant, this efficiency would likely be similar to the conversion efficiency of coal, potentially discounted for the relative moisture content of the stover (see Robinson, Keith, & Rhodes 2001); Carbon intensity of displaced electricity defines the emissions avoided by substituting electricity produced from corn stover for electricity that would otherwise be produced—in the case of stover co-fire with coal in a coal-fired power plant, this would likely be the emissions intensity of electricity produced from coal in that power plant; Energy unit conversion factor is used to convert between Imperial and metric units of measure for fuel heat content (btu or British thermal units and mega joules, respectively).

In Example 7, the algorithm output is the product of all of the factors listed under “Assumptions” above, except “Corn Ethanol Yield” and “Ethanol Heat Content”, the inverses of which are multiplied by the product of the other factors in the algorithm. Example 7 shows one of many possible implementations of the algorithm. Other implementations can be applied within the context of the California Low Carbon Fuel Standard, and other implementations would almost certainly be required to utilize the invention in the context of fuel policies in other jurisdictions (e.g., BC LCFS, UK RTFO and EU RED and FQD). In these and other embodiments, loss factors can be applied or other means of accounting for carbon losses or other GHG emissions from residue carbon losses due to degradation during Residue Storage, transport, and the like. Differences in GHG emissions from biomass transport, due to a process implementation warranting alternate assumptions, for example, would need to be reflected.

### Example 8

### GHG Summary for Corn Ethanol (WCBP, Electricity Co-Product, Mass Allocation Methodology)

Table 7 shows a greenhouse gas emissions summary for dry and wet mill corn ethanol for a WCBP process where electricity is a co-product under a mass allocation methodology. In this mass allocation example, the Ethanol Production Co-products value is still based on system expansion, for consistency with the existing corn ethanol pathway defined by the California Air Resources Board.

TABLE 7

| Corn Ethanol Fuel | Dry Mill Process | Wet Mill Process |
|---|---|---|
| Cycle Components | GHG (gCO₂/MJ) | GHG (gCO₂/MJ) |
| Well-to-tank | | |
| Crop Cultivation | 5.65 | 5.81 |
| Chemical Inputs to Cultivation | 30.2 | 31.35 |
| Corn Transportation | 2.22 | 2.28 |
| Ethanol Production | 38.3 | 48.78 |
| Ethanol Transport & Storage | 2.7 | 2.63 |
| Ethanol Production Co-products | −11.51 | −16.65 |
| Emissions allocated to residue | −12.0 | −12.4 |
| co-product | | |
| Total well-to-tank | 55.6 | 61.8 |
| Tank-to-wheel | | |
| Carbon in fuel | 0 | 0 |
| Total tank-to-wheel | 0 | 0 |
| Total well-to-wheel | 55.6 | 61.8 |

In this example, the regulatory value for dry mill corn ethanol is 55.6 gCO₂/MJ and the regulatory value for wet mill corn ethanol is 61.8 gCO₂/MJ. The Emissions allocated to residue co-product (Emissions from crop cultivation and upstream processes are allocated to residue co-products (to be used for electricity production) pro-rata by mass, as described below in Example 9. Here, emissions from handling of residue co-products are considered as part of the residue co-product supply chain and are not accounted for in biofuel emissions accounting.

### Example 9

### Computational Algorithm for Defining Emissions Accounting Credits Applied in the Context of the California Low Carbon Fuel Standard (WCBP, Electricity Co-Product, Mass Allocation Methodology).

Table 8 shows an example of computational algorithm for defining emissions accounting credits produced by WCBP applied in the context of the California Low Carbon Fuel Standard (electricity co-product, mass allocation methodology). The Emissions allocated to residue co-product values shown in Table 7 were calculated according to the following methodology.

TABLE 8

| | | | |
|---|---|---|---|
| | Dry Mill | Wet Mill | |
| Parameter | Process | Process | Units |

Assumptions

| | | | |
|---|---|---|---|
| Stover:kernel mass ratio | 1 | 1 | kg(stover)/ |
| | | | kg(kernel) |
| Fraction of stover removed | 0.5 | 0.5 | |
| Carbon intensity of whole crop | 35.9 | 37.2 | gCO₂/MJ(eth) |
| produced | | | |

Algorithm output

| | | | |
|---|---|---|---|
| Carbon intensity reduction from | 12.0 | 12.4 | gCO₂/MJ(eth) |
| WCBP | | | |

In this example, the reduction in regulatory value for dry mill corn ethanol is 12.0 gCO₂/MJ and the regulatory value for wet mill corn ethanol is 12.4 gCO₂/MJ.

In Example 9, the Assumptions are defined as follows: Stover:kernel mass ratio defines the ratio of corn stover yield to corn kernel yield on a dry mass basis; fraction of stover removed defines the fraction of corn stover removed from the field, with the remainder assumed to be left in place to advance erosion protection, soil fertility, and/or other agricultural objectives; Carbon intensity of whole crop produced defines the emissions embodied in the total agricultural products destined for products and co-products—in this example it equals the sum of emissions from “Crop cultivation” and “Chemical inputs to agriculture.” E.g., 5.65+30.2=35.9. However, if an emissions accounting framework includes emissions factors for indirect effects of dedicating agricultural production to biofuels (e.g., indirect land use change), then this emissions factor might also be included in determining the “carbon intensity of whole crop produced.”

The Algorithm output is equal to the product of the “Carbon intensity of whole crop produced” and the mass ratio of stover dedicated to co-products to all agricultural outputs destined for products or co-products—in this case the mass ratio is equal to 0.5 (the mass of agricultural residues removed per mass unit of kernels produced for ethanol) divided by 1.5 (the mass of all agricultural outputs destined for products or co-products per mass unit of kernels produced for ethanol). E.g., 35.9*(0.5/1.5)=12.0.

### Example 10

### Applications of TARM to LCA

Fuels are increasingly regulated using measures of fuel carbon intensity (CI) that are determined using lifecycle analysis (LCA). LCA is generally an assumption driven exercise, where assumptions are used to characterize fuel supply chains and system performance. Assumptions can be modified to reflect alternate supply chains or particular characteristics of specific supply chains. In this way, CI values can be assessed for each supply chain in advance, and each fuel can be associated with and regulated according to the CI value for supply chain used to provide the fuel. This basic approach is being adopted by a number of climate motivated fuel policies in the US, Canada, and Europe. However, this approach may pose unique challenges for fuels produced with emissions credits that depend in some way on supply chain activities that may not be directly required for fuel production and/or that vary continuously over some range of potential values. In such cases, it can be difficult to specify a single CI value for all fuel supplied according to a particular supply chain, or to differentiate alternate supply chains with which a particular batch of fuel is supplied. The invention provides methods and machines for implementing LCA.

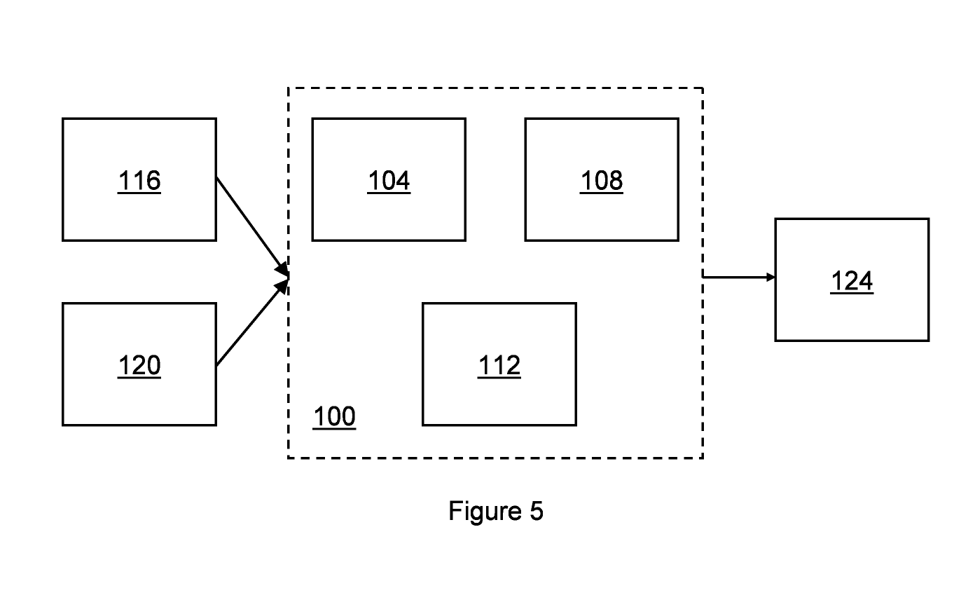

FIG. 5 illustrates a tracking, accounting and reporting machine 100, including a tracking module 104, an accounting module 108 and a reporting module 112. The machine 100 is configured to process the algorithms described herein. The machine 100 receives input information from one of two input modules 116 and 120, and generates an output 124. The tracking module 104, accounting module 108 and reporting module 112 can be associated with a single computing device or can be associated with individual computing devices. In certain embodiments, the functional equivalent of the three modules is integrated into one module, e.g., the tracking module 104, the accounting module 108 and the reporting module 112 are integrated into a single module of machine 100. Each module is capable of receiving input and generating output. In some embodiments, there is a flow of input information from the tracking module 104 to the accounting module 108 to the reporting module 112 to generate the output 124. Each module can be associated with a database and memory for storage of information and a process for computation.

### Example 10.1

### WCBP/SPBCS

In biofuel supply chains employing WCBP and SPBCS the CI of the fuel depends in part on the quantity of agricultural residues and the use of those agricultural residues. The quantity of agricultural residues harvested can range from 0% to 100% of the residues produced during biofuel feedstock production, though the practical upper limit may be substantially less than 100%. Importantly, the quantity of residues harvested may vary from one field or farm to another (e.g., depending on soil conditions or available equipment) and may vary from one year to another. Moreover, the use of those residues may vary, as farmers sell residues for use in multiple applications. As a result, it may be difficult to specify the CI of the associated ethanol in advance. Moreover, it may not be convenient or even feasible to process biofuel feedstock in batches that can be associated with CI values that are specified in advance.

In the context of WCBP, inputs can include physical activities in the agricultural supply chains. For example, feedstock information can be inputted as input module 116. Feedstock information can include, but is not limited to, farm activities for kernel production and harvest, kernel transport (to storage & to ethanol plant), kernel storage (on-field &/or offsite, e.g., grain elevator), kernel utilization to produce ethanol, and ethanol transport & handling. Residue information can be inputted as input module 120. Residue information can include, but is not limited to, analysis to support residue removal (e.g., sustainability analysis), farm activities for residue harvest & removal, residue transport (to storage & to utilization facility), residue storage (on-field &/or offsite, e.g., grain elevator), and residue utilization for heat & power.

The machine 100, or one of its affiliated modules 104, 108 or 112, can collect and import data, maintain a database of supply chain activities and/or CI impacts of those activities. The machine (e.g., tracking module 104) can include tools for assigning activities and CI impacts (from input module 120) to fuel batches (from input module 116). The machine 100 (e.g., accounting module 108) can include algorithms for computing CI values of fuels and matching to established fuel pathways. The machine (e.g., reporting module 112) can include a “document” automation, export facility, & tools to publish information (e.g., to a third party accessible database service).

Output 124 from the machine 100 (or at least one module of the machine) can include, but is not limited to, a report defining the quantity, fuel pathway, and CI value for a particular batch of ethanol supplied, a file containing documentation of each activity (in all relevant supply chains) related to each batch of fuels, or a database service enabling third parties to review fuel reports and documentation of each related activities, e.g., for verification purposes.

### Example 10.2

### Low CI Hydrocarbons

In the supply chains of hydrocarbon fuels (e.g., gasoline, diesel, natural gas, etc.) where CO₂ derived from the atmosphere is injected and sequestered in geologic formations from which raw hydrocarbons are produced (e.g., via CO₂ enhanced oil recovery), the CI of the resulting fuels depends in part on the quantity of injected CO₂ that is derived from the atmosphere. Some of the CO₂ or other injection fluids may be derived from other geological formations, from industrial sources, from fossil fuel combustion, or from the atmosphere—either directly via industrial air capture systems or indirectly via biomass energy production with CO₂ capture—each CO₂ source may have different impacts on lifecycle measures of CI or other sustainability metrics. The relative contributions of these alternative sources of CO₂ for injection, the emissions impacts of associated co-products, and the quantity of CO₂ effectively sequestered in geologic formations may vary over time and from one well to another. As a result, it may be difficult to specify the CI of associated hydrocarbon fuels in advance. Moreover, it may not be convenient or even feasible to process raw hydrocarbons in batches that can be associated with CI values that are specified in advance. Information such as this can be received by one of the input modules 116 or 120.

### Example 10.3

### Algae Production

In supply chains in which CO₂ and/or other inputs is supplied to algae production and resulting algae is converted into biofuels and/or related products, the CI of the resulting algae-derived fuels depends in part on the source of the CO₂, which may include geological sources, industrial sources, fossil fuel combustion, or atmospheric sources—either via direct CO₂ capture from the air or indirectly via biomass combustion with CO₂ capture. The relative contributions of alternative sources of CO₂ and/or other production inputs and/or the emissions impacts of associated co-products may vary over time and from one algae production area to another. As a result it may be difficult to specify the CI of associated algae derived fuels in advance. Moreover, it may not be convenient or even feasible to process algae in batches that can be associated with CI values that are specified in advance. Information such as this can be received by one of the input modules 116 or 120.

Systems for atmospheric carbon dioxide capture include, but are not limited to: direct capture of atmospheric carbon dioxide using solid sorbents that are regenerated using changes in temperature, moisture, and/or pressure to produce a concentrated carbon dioxide gas. These systems may use, for example, solid amines as or ion-exchange media as a solid sorbent media for carbon dioxide.

For example, capture of carbon dioxide can be applied to large point sources, such as fossil fuel or biomass energy facilities, major carbon dioxide-emitting industrial plants, natural gas production, petroleum production or refining facilities, synthetic fuel plants and fossil fuel-based hydrogen production plants. Sources include industrial sources of carbon dioxide (such as natural gas processing facilities and steel and cement producers), oxyfuel combustion, pre-combustion (such as hydrogen and fertilizer production, and power plants using gaseous fuels and/or solid fuels that are gasified prior to combustion), and post-combustion facilities (such as heat and power plants).

In an industrial separation route, a raw material and a fuel (e.g., a fossil fuel or biomass) are provided to an industrial process, which outputs a product containing carbon dioxide. The carbon dioxide is separated from the product output and then compressed through a compression process. Several industrial applications involve process streams from which carbon dioxide can be separated and captured. The industrial applications include for example iron, steel, cement and chemical manufacturers including ammonia, alcohol, synthetic liquid fuels and fermentation processes for food and drink.

In a post-combustion separation route, a fuel and air are provided to a combustion process, which outputs heat, power, and a product containing carbon dioxide. The carbon dioxide is separated from the product output and then compressed through a compression process. Capture of carbon dioxide from flue gases produced by combustion of fossil fuels (e.g., coal, natural gas, and/or petroleum fuels) and biomass in air is referred to as post-combustion capture. Instead of being discharged directly to the atmosphere, flue gas is passed through equipment which separates most of the carbon dioxide from the balance of flue gases. The carbon dioxide may be compressed for transport and fed to a storage reservoir and the remaining flue gas is discharged to the atmosphere. A chemical sorbent process, including amine based sorbents, for example, is typically used for carbon dioxide separation in post combustion carbon dioxide capture.

In a pre-combustion separation route, a fuel and, for instance, air or oxygen and steam, are provided to a gasification process, which outputs hydrogen and carbon dioxide. The output is separated so that the carbon dioxide is then compressed through a compression process, and heat, power, and other products are extracted from the hydrogen. Pre-combustion capture may involve reacting a fuel with oxygen or air and/or steam to give mainly a “synthesis gas (syngas)” or “fuel gas” composed of carbon monoxide and hydrogen among other compounds. The carbon monoxide may be reacted with steam in a catalytic reactor, called a shift reactor, to give a syngas rich in carbon dioxide and hydrogen. Carbon dioxide may be separated, usually by a physical or chemical absorption process, including glycol based solvents, for example, resulting in a hydrogen-rich fuel gas which can be used in many applications, such as boilers, furnaces, gas turbines, engines, fuel cells, and chemical applications. Other common compounds in syngas include, for example, carbon dioxide, methane, and higher hydrocarbons, which may be “cracked,” “reformed,” or otherwise processed to yield a desirable syngas composition, including, for example high concentrations of hydrogen, carbon monoxide, and carbon dioxide.

In an oxyfuel separation route, a fuel and oxygen (e.g., separated from air) are provided to a combustion process, which outputs heat, power, and carbon dioxide that is then compressed through a compression process. In oxy-fuel combustion, nearly pure oxygen is used for combustion instead of air, resulting in a flue gas that is mainly carbon dioxide and water. If fuel is burnt in pure oxygen, the flame temperature may be excessively high, but carbon dioxide and/or water-rich flue gas can be recycled to the combustor to moderate the temperature. Oxygen is usually produced by low temperature (cryogenic) air separation or other techniques that supply oxygen to the fuel, such as membranes and chemical looping cycles. The combustion systems of reference for oxy-fuel combustion capture systems are the same as those noted above for post-combustion capture systems, including power generation and/or heat production for industrial processes.

Considering Example 10.1 and machine 100, the CI of biofuel depends in part on the quantity of residues/co-produced biomass harvested and on the use of that biomass (e.g., for electricity generation, for a coal substitute, for cellulosic ethanol generation, or for carbon sequestration).

CIp=f(Qu)
Where,
CIp=the fuel carbon intensity (or GHG intensity) for fuel pathway “p”
Qu is the quantity of residues used in utilization application “u”

As such, a unique fuel pathway can be defined for each residue utilization application and for each quantity of agricultural residues that can be harvested for use in residue utilization applications. Biofuel producers can then define the CI of their fuels from a menu of fuel pathways according to the quantity of residues harvested and the use of those residues. While theoretically straightforward, this may be difficult in practice, as the quantity of residues actually harvested varies across a continuous range and because residue utilization may vary over time, requiring a system of tracking both residues and associated biofuel feedstock in real-time. This way, the fuel pathway for the resulting quantity of biofuel can be specified at the time the residue utilization is determined.

The invention provides a parallel real-time tracking system and algorithm that enables the CI of the biofuel feedstock and subsequent biofuel to be defined according to the utilization of associated agricultural residues, once the quantity and utilization of residues are specified. For example, each unit of feedstock and residues can be assigned unique alphanumeric identifiers that are associated with one another in a database. The disposition of each unit of feedstock and residues can be tracked through their respective supply chains, as packages and inventory may be tracked in conventional supply chains. When the disposition of residues is specified, any resulting emissions credit can be computed, allocated to the associated biofuel feedstock and used to inform/update the CI of resulting biofuels. Records documenting the production, handling, and disposition of both biofuel feedstock and associated residues can be compiled separately and associated with each other to provide appropriate documentation for CI verification purposes.

If residues associated with a particular batch of biofuel are used in more than one residue utilization application, then each application can be considered in defining fuel CI values. In this context, the quantity of biofuel is known and the challenge is defining the appropriate CI value.

The system is unique in providing parallel, real-time tracking of two distinct product streams so that the value of one product (the biofuels) can be determined based on the disposition of the other (the residues). The benefits of the parallel tracking, CI computation, and reporting system did not exist prior to CI based regulations of biofuels and the conception of WCBP/SPBCS biofuel production systems.

In one implementation the following data tables are created in a database system associated with machine 100 or one or more of its modules: Feedstock Data Table; Residue Data Table; Baseline Biofuel Pathway Data Table (or biorefinery data table that includes biofuel pathways available for each biorefinery); and Residue Utilization Application Data Table.

An entry is created in the Feedstock Data Table each time biofuel feedstock is removed from a field. Each entry includes a unique alphanumeric identifier, which may be automatically generated, and information regarding the feedstock removed. This information can include the quantity of feedstock, measured in units of mass (e.g., kg or tons) or other convenient units (e.g., bushels); data regarding the quality of the feedstock (e.g., moisture content); data regarding the location of production (e.g., the field or farm name, global positioning data, etc.); a unique alphanumeric identifier associated with the residue utilization application; and data required to retrieve supporting documentation from a document repository (e.g., document identifiers for purchase and sale agreements, bills of lading, etc.). In addition, the entry would include a place for recording a unique alphanumeric identifier for agricultural residues produced with the feedstock. The residue identifier may be produced at the time the Feedstock Data Table entry is completed, or may be produced when a corresponding entry is completed in the Residue Data Table. Additional entries may be created in the Feedstock Data Table, or additional data can be inserted into an existing Feedstock Data Table entry, as the feedstock progresses through the supply chain (e.g., moved from the harvest location to a storage facility, moved from the storage facility to biorefinery, fed into the biorefinery for biofuel production, converted in the biorefinery to particular units of biofuel). Any division of feedstock represented in a particular entry in the Feedstock Data Table to supply multiple biorefineries would be represented by creating additional entries, and/or entering additional data in an existing entry, within the Feedstock Data Table. In this way each unit of biofuel produced can be traced to one or more particular quantities of biofuel feedstock removed from particular production sites, and chain of custody of the feedstock can be verified.

An entry is created in the Residue Data Table each time biofuel feedstock residue (i.e., the biomass produced along with biofuel feedstock that might be removed for SPBCS and/or WCBP) is removed from a field. Each entry can include a unique alphanumeric identifier, which may be automatically generated, and information regarding the residues removed. This information may include: the quantity of residue, measured in units of mass (e.g., kg or tons) or other convenient units (e.g., bales); data regarding the quality of the feedstock (e.g., moisture content); data regarding the location of production (e.g., the field or farm name, global positioning data, etc.); a unique alphanumeric identifier associated with the residue utilization application (providing a reference to the Residue Utilization Application Data Table), and data required to retrieve supporting documentation from a document repository (e.g., document identifiers for purchase and sale agreements, bills of lading, etc.). In addition, the entry would include a place for recording a unique alphanumeric identifier for biofuel feedstock produced with the residues. The biofuel feedstock identifier may be produced and entered at the time the Residue Data Table entry is completed, or may be produced when a corresponding entry is completed in the Feedstock Data Table. Additional entries can be created in the Residue Data Table, or additional data can be inserted into an existing Residue Data Table entry, as the residue progresses through the supply chain (e.g., moved from the harvest location to a storage facility, moved from the storage facility to a residue application facility, fed into the residue application facility, converted in the biorefinery to particular units of residue products). Any division of residues represented in a particular entry in the Residue Data Table to supply multiple residue utilization applications would be represented by creating additional entries, and/or entering additional data in an existing entry, within the Residue Data Table. In this way each unit of residues used in each residue utilization application, or resulting in each residue utilization application product, can be traced to one or more particular quantities of residue removed from particular production sites, and chain of custody of the residue can be verified.

As noted, each entry in the Residue Data Table can contain a reference to one or more the unique alphanumeric identifier of entry(ies) in the Biofuel Feedstock Data Table, and vice versa. These references between entries in each table may include reference to the particular geographic location or party responsible for agricultural production. References to geographical location (or responsible party) may also be present in an optional table of agricultural producers. Additional data associated with the geographical location (or responsible party) may also be included in one or more of these tables, including potentially information regarding maximum sustainable residue removal rates and or other environmental parameters or characteristics of the producer, which may be tracked separately and/or referenced within feedstock and residue tracking to ensure that sustainability and other potential constraints on the various supply chains are met. The references between entries in the Residue Data Table and Biofuel Feedstock Data Table enable each unit of biofuel feedstock and biofuel produced to be associated with the use of residues resulting as a consequence of biofuel feedstock production. In other words, cross references to unique alphanumeric identifiers between entries in the Biofuel Feedstock Data Table and the Residue Data table enables concurrent or parallel tracking of biofuel feedstock and the residues produced within the biofuel supply chain. This enables the emissions and or sustainability benefits of the residue utilization application to be attributed to the biofuel produced and the biofuel CI value to be adjusted accordingly, for example. Importantly the CI values do not need to be determined at the time of biofuel feedstock harvest based on uncertain assumptions, but can be resolved over time as the disposition of residues occurs and is documented. References to transaction documentation recording the progress of both biofuel feedstock and associated residues through their respective supply chains enables the production of complete documentation supporting the resulting environmental performance and/or CI value of the biofuel.

Determining the appropriate characterization of environmental performance and computation of the appropriate CI values for biofuels can require reference to information regarding the environmental performance of both the biofuel feedstock supply chain and the agricultural residue supply chain. Within the current example/embodiment, this information is provided in the Baseline Biofuel Pathway/Biorefinery Data Table and the Residue Utilization Application Data Table.

The Baseline Biofuel Pathway/Biorefinery Data Table can contain information about the biofuel feedstock supply chain. For example, it might contain biofuel pathways listed in the Lookup Tables published by California's Air Resources Board for implementation of the California Low Carbon Fuel Standard (“CA Lookup Tables”). A distinct entry can be established for each fuel pathway. Each entry can contain a unique alphanumeric identifier for the fuel pathway, the fuel CI value established for the fuel pathway, and the rate by which biofuel feedstock is converted to biofuel within the fuel pathway. Note that the CA Lookup Tables specify CI in units of mass GHG per unit biofuel energy (i.e., gCO₂e/MJ). As a result, the biofuel feedstock to biofuel conversion rate is needed to specify the quantity of biofuel feedstock associated with each unit of biofuel produced, and vice versa. This conversion factor might be specified in units of MJ biofuel per unit mass (e.g., MJ/kg) or other convenient unit used for quantifying feedstock (e.g., MJ/bushel).

The Baseline Biofuel Pathway/Biorefinery Data Table can also contain information regarding individual biorefineries and the fuel pathways by which they are qualified to supply biofuels. This information can also be provided in a separate data table, or can be excluded from the database system.

The Residue Utilization Data Table contains information about the residue supply chain. For example, it might contain unique entries for each residue utilization application. Each entry can contain: a unique alphanumeric identifier for the residue utilization application; the emissions, CI, or environmental performance benefit associated with the residue utilization application. The emissions, CI, or environmental performance benefit can be defined per unit mass (e.g., gCO₂e/kg) or other convenient unit used for quantifying residues. It can be quantified per unit residues on an “as received” basis or conditioned upon data regarding the residue's quality, for example on a “dry” basis, in which case data regarding both the residue's mass and quality (e.g., moisture) recorded in the Residue Data Table would be required to compute the emissions, CI, or environmental performance benefit associated with using any particular quantity of residues in each residue utilization application.

The Residue Utilization Application Data Table might also contain information regarding individual residue utilization facilities, the residue utilization applications available at each facility, and other information, such as the location of the facilities. This information can also be provided in a separate data table, or can be excluded from the database system, depending on the level of specificity required in the associated computations and relevant data reporting mechanisms.

In this embodiment/example, the emissions, CI value, and/or environmental performance of each unit of biofuel produced are computed from data provided in each of the data tables described above. This computation can be understood by breaking it down into a series of steps. These steps are used here for explanatory purposes only, and the actual system may or may not be organized into similar steps.

Step 1: Define LCA credit from residue utilization. The LCA credit (emissions, CI, or environmental performance) is computed for each entry in the Residue Data Table from data within that entry and from data in the Residue Utilization Application Data Table. For example, a quantity GHG emissions credit (e.g., gCO₂e) can be computed as the product of the mass of residues (tons) utilized and the emissions benefit provided in the appropriate Residue Utilization Application Data Table entry. The appropriate entry is determined by matching the alphanumeric identifier listed in the Residue Utilization Table entry for the residues of interest against the alphanumeric identifiers provided for each residue utilization application in the Residue Utilization Application Data Table.

Sample computation:
Residue Data Table entry with identifier RDT0012 indicates that the 10 tons of residue described in this entry was used in the residue utilization application with identifier RUA0034;
Residue Utilization Application Data Table entry with identifier RUA0034 indicates a lifecycle GHG emissions benefit of 1 ton CO₂e per ton of residues utilized in this application;
The net GHG emissions benefit attributable to the residue represented by Residue Data Table entry RDT0012 is defined as:
   10 (tons residues)×1 (tCO₂e/ton residues)=10 tons CO₂e

This result can be added to Residue Data Table entry RDT0012, computed from the relevant data and assigned directly to associated biofuel entries in the Feedstock Data Table, or computed separately and assigned to relevant units of biofuel without adding the computation results to any of the data tables described here.

Step 2: Define LCA credit for biofuel feedstock. Step 1 established the LCA credit associated with Residue Data Table entry RDT0012. In this step, the resulting credit must be assigned to the appropriate unit of biofuel feedstock and potentially converted into units that are more useful for describing fuel CI. Assigning the credit to the appropriate unit of feedstock is accomplished using references between entries in the Feedstock Data Table and the Residue Data Table. Potential unit conversion is accomplished using the data provided in the Feedstock Data Table.

Sample computation:
Residue Data Table entry RDT0012 references Feedstock Data Table entry FDT0056, indicating that the 10 tons of residues represented by RDT0012 was produced as a consequence of producing the feedstock represented by Feedstock Data Table entry FDT0056.
Feedstock Data Table entry FDT0056 indicates that 1,200 bushels of corn are described in this entry, which were produced with the 10 tons of residues described in Residue Data Table entry RDT0012.
The 10 tCO₂e emissions credit computed in step 1 is then assigned to the biofuel feedstock represented by entry FDT0056.
This emissions credit can be converted to an emissions intensity, which may be more convenient, by dividing it by the quantity of feedstock represented in the entry:
   10 (tons CO₂e)/1,200 (bushels corn)=0.0083 (tCO₂e/bu)=8,300 (gCO₂e/bu)

This result can be added to Feedstock Data Table entry FDT0056, computed from the relevant data and assigned directly to resulting biofuel in the Feedstock Data Table, or computed separately and assigned to relevant units of biofuel without adding the computation results to any of the data tables described here.

Step 3: Defining the LCA credit for resulting biofuels. Step 2 established the LCA emissions credit associated with the biofuel feedstock represented in Feedstock Data Table entry FDT0056. In this step the credit needs to be assigned to an appropriate quantity of biofuels produced and potentially converted into more convenient units. This is accomplished using the data contained in the Baseline Biofuel Pathway/Biorefinery Data Table referenced in the Feedstock Data Table entry of interest.

Sample computation:
Feedstock Data Table entry FDT0056 references Baseline Biofuel Pathway/Biorefinery Data Table entry BDT0078, indicating that the 1,200 bushels of corn represented in entry FDT0056 was converted to biofuel using the biofuel pathway represented by Baseline Biofuel Pathway/Biorefinery Data Table entry BDT0078.
Baseline Biofuel Pathway/Biorefinery Data Table entry BDT0078 indicates that this fuel pathway has a feedstock to biofuel conversion rate of 216 MJ of biofuel per bushel of corn.
The emissions intensity credit computed in Step 2 is then assigned to the resulting biofuel and converted into more convenient units using this conversion rate:
   8,300 (gCO₂e/bu)/217 (MJ/bu)=38 (gCO₂/MJ)

Step 4: Defining CI value for resulting biofuels. Step 3 assigned the LCA emissions intensity credit to the biofuel product resulting from the feedstock supply chain utilizing the biofuel feedstock represented in Feedstock Data Table entry FDT0056 and converted that intensity credit into more convenient units for computing the appropriate fuel CI value. In this step, the biofuel emissions intensity credit is used with data in the Baseline Biofuel Pathway/Biorefinery Data Table to compute a final CI value for the biofuel product. This is accomplished by subtracting the biofuel emissions intensity credit from the CI value indicated for the appropriate entry in the Baseline Biofuel Pathway/Biorefinery Data Table.

Sample computation:
Baseline Biofuel Pathway/Biorefinery Data Table entry BDT0078 indicates that this fuel pathway has a baseline CI value (i.e., CI value before accounting for residue utilization) of 77 gCO₂/MJ.
The biofuel CI value is computed by subtracting the emissions intensity credit defined in Step 3 from the baseline fuel CI value:
   77 (gCO₂e/MJ)−38 (gCO₂e/MJ)=39 gCO₂e/MJ

This biofuel CI value can then be assigned to the biofuel produced from the biofuel feedstock represented in Feedstock Data Table entry FDT0056. This value may be entered into one or more of the data tables described above (e.g., the Feedstock Data Table), or may be computed and recorded independently. All transaction records documenting the supply chains for both the feedstock and associated residues supporting this CI value can be provided by compiling the transaction documents referenced in the relevant table entries.

Note that the use of residues in multiple residue utilization applications and the use of feedstock in multiple biorefineries can be easily accounted for within the system described above. For example, each unit of biofuel product can be divided into quantities representing a single residue utilization application (as described below) or the CI value can be defined according to reflect the total emissions credits computed as the sum of each emissions credit for each residue utilization application (computed in Step 1 of the example above) indicated in the Residue Data table within the example above.

The example provided above describes one potential embodiment of the disclosed system for tracking, accounting, and reporting fuel CI values that reflect the contributions of supply chains for both biofuel feedstock and associated agricultural residues. Many other embodiments can be conceived from the basic teachings provided in this disclosure. Central contribution of this invention include: the parallel tracking of both biofuel feedstock and associated agricultural residues through their respective supply chains; and the integration of LCA accounting information regarding these distinct supply chains to provide a clear and verifiable accounting of biofuel lifecycle environmental performance, including quantification of emissions performance as fuel CI values.

In the above discussion, the quantity of biofuels is known and the invention provides a mechanism for tracking, accounting, and reporting the information relevant to determining the fuel CI. However, this may be challenging to report efficiency within a regulatory structure that requires quantities of biofuel to be associated with pre-defined fuel pathways and pre-defined CI values. This is because the quantity of residues harvested can vary over a continuous range (e.g., be any value between 0% and 100% of the residues produced), because of the diversity of potential residue utilization applications, and because the proportion of residues used in each application can vary between 0% and 100% of the quantity harvested.

### Example 11

### Calculations for a Weighting Function/Fuel Mixture Method and an LCA Ratio Method

In various embodiments, the implementation of TARM algorithm-based methods can provide for the definition of equivalent quantities of biofuel produced according to established fuel pathways using actual supply chain data.

In a weighting function/fuel mixture implementation, the fuel actually produced (with supply chain data) is treated as a mixture of two registered fuel types—one with CI (or residue usage rates) greater than the fuel actually produced, one with CI (or residue usage rates) lower than the fuel actually produced. Algebra can be used to derive a function for the weighting factor “y,” which can be used to define the fraction of fuel produced that is equivalent to each established fuel pathway.

Qₘ·CIₘ=y·Qₘ·CI_{R+}+(1−y)·Qₘ·CI_{R-}

CIₘ=y·CI_{R+}+(1−y)·CI_{R-}

Solving for y yields:

y=(CIₘ−CI_{R-})/(CI_{R+}−CI_{R-})

Registered Fuel Types

Q_{R+}=y·Qₘ

Q_{R-}=(1−y)·Qₘ

where m=measured quantity, R+=Registered CI above measured CI and R−=Registered CI below measured CI.

An LCA ratio implementation is based on an assumption that the difference between alternate pathways is only the residue usage rate, which is specified in (or can be calculated from) information in the pathway's LCA. In this case, the quantity of fuel produced according to each fuel pathway can be the measured quantity of residues utilized (e.g., tons used in a particular application) divided by the residue usage rates associated with established fuel pathways. Alternatively, one may need to take into account additional considerations such as harvest rate. In this way, equivalent quantities of biofuels can be specified for each available pathway.

Ratio of fuel quantity to residue processed of the LCA

LCA_{CIR}˜Qf_{CIR}/Q_{R}

Quantity of fuel produced with CI_{R}=Measured quantity of residue processed×Ratio of LCA

Qf_{CIR}=Q_{R}×Qf_{CIR}/Q_{R}

where R is the residues and f_{CIR} is a fuel with a registered CI value.

These implementations provide unique methods of computing the quantity of fuel produced as a function of a measure of residue usage (or “atmospheric” CO₂ sequestered in LCIP applications, for example).

Considering Example 10.2 and machine 100, the CI of hydrocarbons, hydrocarbon fuels, and/or related product depends in part on the quantity, source, and co-products of CO₂ supplied for hydrocarbon production.

CIp=f(Qs,Rs)
Where,
CIp=the fuel carbon intensity (or GHG intensity) for fuel pathway “p”
Qs=the quantity of CO₂ supplied from source “s”, with its associated co-products
Rs=the rate of CO₂ effectively sequestered away from the atmosphere

As such, a unique fuel pathway can be defined for each CO₂ source, associated co-product(s), and CO₂ sequestration rate. Hydrocarbon producers can then define the CI of their product hydrocarbon, hydrocarbon fuel, and or related products from a menu of fuel pathways according to the quantity of CO₂ supplied, the source of CO₂ supplied, and the CO₂ sequestration rate. While theoretically straightforward, this may be difficult in practice, as the relative quantity of CO₂ supplied from each source may vary across a continuous range (from 0% to 100%), the associated co-products and/or emissions effects of those co-products may vary over time, and the quantity (or rate) of CO₂ effectively sequestered away from the atmosphere may vary over time or from well to well, thus requiring a system of tracking hydrocarbon production, CO₂ sources, associated co-products, and CO₂ sequestration in real-time. This way, the fuel pathway for the resulting quantity of hydrocarbon, hydrocarbon fuel, and/or related product can be specified at the time that production, CO₂ utilization rate, CO₂ sources, associated co-products, emissions impacts of those co-products, and CO₂ sequestration rate are specified.

The invention provides a real-time tracking system and algorithm that enables the CI of the hydrocarbon, hydrocarbon fuel, and/or related products to be defined according to the quantity of CO₂ supplied from each source, the emissions profile and co-products associated with each source, and the rate of CO₂ sequestration in the geologic formation(s). For example, each CO₂ source can be assigned a unique alphanumeric identifier, which can be associated with the emissions intensity of its supply, the emissions effects of its co-products, and with specific units of CO₂ supplied from that source for hydrocarbon production. Each hydrocarbon production site or well can also be assigned a unique alphanumeric identifier, which can be associated with hydrocarbons produced and with characterization of CO₂ sequestration during hydrocarbon production, established via direct and/or indirect monitoring of injection as well as potential fugitive CO₂ emissions, CO₂ recovery in produced hydrocarbons, and CO₂ separation and re-injection. CI values for hydrocarbons, hydrocarbon fuels, and related products from each injection/hydrocarbon production site can then be determined and assigned according to actual CO₂ sources used for production, the emissions intensities and co-products of those sources, and actual sequestration rates, which may vary over time or from one well to another.

Documents specifying the CO₂ sources, carbon intensities and co-products associated with each CO₂ source, and CO₂ sequestration rates and/or quantities of CO₂ sequestered in the production of each unit of hydrocarbon, hydrocarbon fuel, and/or related product can be auto-generated and published for regulatory compliance purposes. Documents and records of each component of supply—including for example transaction documents for CO₂ supply and co-products of CO₂ supply—used to determine the assigned CI values can then be complied for consolidated with auto-generated documents for regulatory compliance purposes and archived for future reference, for example in the event of an audit of the assigned CI value(s)

The system is unique in providing real-time tracking of CO₂ supply, including emissions intensity of supply and potential co-products of supply, CO₂ sequestration rates in hydrocarbon production, determination and assignment of hydrocarbon CI values, auto-generation of reporting and compliance documents, consolidation of records evidencing CI determinations, and archiving of such documents for regulatory compliance purposes. The benefits of such systems did not exist prior to CI based regulations of hydrocarbon fuels and the conception of CO₂ injection and sequestration for the purpose of producing low CI hydrocarbon fuels.

In one implementation the following data tables are created in a database system associated with machine 100 or one or more of its modules: CO₂ Source Data Table; CO₂ Supply Data Table; and Hydrocarbon Production Data Table. Note that the invention can be implemented in a way that integrates the CO₂ Supply Data Table with either the CO₂ Source Data Table or the Hydrocarbon Production Data Table or both. A benefit of desegregating these various data management activities via linked data tables as described in this example is to distribute data collection and management across potentially distinct operational units of the implementing organization(s).

An entry is created in the CO₂ Source Data Table for each source of CO₂ used for hydrocarbon production. Each entry may include a unique alphanumeric identifier and information characterizing the CO₂ source, including particularly the potential quantities or rates of CO₂ supply, the emissions intensity (or other relevant metrics of sustainability) of supply from that source, the quantities or rates of co-products produced as a consequence of CO₂ supply, and the impact of those co-products on emissions intensity (or other relevant metrics of sustainability), which might be assigned to the CO₂ and hydrocarbons subsequently produced. The data table may include links to documents evidencing various aspects of this information, including, for example, co-product production records, sales receipts, lifecycle analyses of the carbon intensity of the source (including emissions impacts of co-products), lifecycle analysis and/or CI values and/or CI credits that might be applied to hydrocarbons produced with CO₂ from the CO₂ source, potentially with different assumed CO₂ sequestration rates, and other similar supporting documents.

Note that the co-products associated with a particular source of CO₂ may change over time. As such, entries in the CO₂ Source Data Table may be updated periodically. Each updated entry may be assigned a new time period of applicability and the previous entry retained for documenting or evidencing the CI of hydrocarbons produced prior to the CO₂ Source Data Table update.

An entry is created in the CO₂ Supply Data Table for each unit of CO₂ supplied for hydrocarbon production or each time period during which CO₂ is supplied for hydrocarbon production. Each entry may include a unique alphanumeric identifier and information characterizing the CO₂ supplied, including for example the total quantity of CO₂ supplied, the quantity supplied from each source including the appropriate alphanumeric identifier(s), the hydrocarbon production site(s) to which CO₂ is supplied, and the time period during which the CO₂ is supplied. Use of the alphanumeric identifier(s) for the source(s) of CO₂ supply (along with the time of CO₂ supply) enables appropriate accounting of the emissions intensity of CO₂ supply, including emissions effects of CO₂ supply co-products.

An entry is created in the Hydrocarbon Production Data Table for each production site, well, or borehole used to produce hydrocarbons with CO₂ injection. Each Hydrocarbon Production Data Table entry would contain a unique alphanumeric identifier for the site and information characterizing the operations of the site at a particular period in time and potential baseline CI values for hydrocarbons produced (e.g., without credits specific to CO₂ sources and associated co-products), potentially with multiple modes of operation (e.g., multiple extents of CO₂ separation from product hydrocarbons and re-injection). The information may include data characterizing quantities of CO₂ injected, quantities of fugitive emissions observed or estimated, quantities of hydrocarbons produced, quantities of injected CO₂ present in produced hydrocarbons measured or estimated, and quantities of such CO₂ separated from produced hydrocarbons for reinjection. This data may be used to compute CO₂ sequestration rates for the site and for associated hydrocarbons produced.

Considering Example 10.3 and machine 100, the CI of algae, algal fuel, and/or related product depends in part on the quantity, source, and co-products of CO₂ supplied for algae production.

CIp=f(Qs)
Where,
CIp=the fuel carbon intensity (or GHG intensity) for fuel pathway “p”
Qs=the quantity of CO₂ supplied from source “s”, with its associated co-products

As such, a unique fuel pathway can be defined for each CO₂ source and associated co-product(s). Algae producers can then define the CI of their product algae, algal fuels, and or related products from a menu of fuel pathways according to each source of CO₂ supplied. While theoretically straightforward, this may be difficult in practice, as the relative quantity of CO₂ supplied from each source may vary across a continuous range (from 0% to 100%) and the associated co-products and/or emissions effects of those co-products may vary over time, thus requiring a system of tracking algae production, CO₂ sources, and associated co-products in real-time. This way, the fuel pathway for the resulting quantity of algae, algal biofuel, and/or related product can be specified at the time algae production, CO₂ sources, associated co-products, and emissions impacts of those co-products are determined. Note that co-products and emissions impacts of algae production may also vary over time, and therefore may also need to be tracked and considered in real time for effective CI determination.

The data provided in the CO₂ Source Data Table, CO₂ Supply Data Table, and Hydrocarbon Production Data Table are sufficient for defining CI values for each unit of hydrocarbons, hydrocarbon fuels, and/or related product produced using real-time data on CO₂ sources, co-products, and CO₂ sequestration/leakage rates rather than simplified assumptions. Cross references between the data tables, including for example unique alphanumeric identifiers for CO₂ sources and hydrocarbon production facilities, enable the data integration to associate specific units of hydrocarbons with specific CO₂ sources, co-products, and sequestration rates. CI values can be computed either using the weighted average methodology or by dividing the product hydrocarbon, hydrocarbon fuel, or related product into portions and associating each portion to a pre-specified CO₂ source, LCA, and/or fuel pathway. CO₂ supply can be tracked (e.g., using the three tables described above) either for each unit of CO₂ supplied or for each injection site, hydrocarbon production site, wellbore or network of such sites/facilities. Documents reporting the results of such computations, including any combination of resulting quantities and CI values of hydrocarbons, hydrocarbon fuels, and/or related products, production facilities, CO₂ sources, associated co-products, CO₂ sequestration rates, and emissions effects of each system component can be auto-generated using a data processor with access to the information contained in the data tables described above. Such auto-generated documents can be formatted to enable streamlined submission for regulatory reporting and compliance purposes. Optional references to supporting documents (e.g., transaction documents, production records, observational records & measurements) enables files to be compiled for each unit of hydrocarbon, hydrocarbon fuel, and/or related product evidencing each step of the production process and of the CI computation. Such consolidated files evidencing CI determination can be submitted for regulatory compliance purposes and/or archived for future reference in preparation for potential future auditing or verification activities

The foregoing examples present illustrative embodiments of the invention and numerous other embodiments are readily implementable, using the teachings and suggestions of this disclosure. For example, other embodiments can exist within the California Low carbon fuel standard, as well as in the context of similar and analogous fuel policies in other jurisdictions (e.g., UK RTFO and EU RED and FQD). Likewise, other embodiments can account for different combinations of system components. For example, loss factors can be applied to reflect residue carbon losses due to degradation during Residue Storage, transport, and the like.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, tablet) with a world wide web browser (e.g., Microsoft® Internet Explorer® available from Microsoft Corporation, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method comprising:
tracking, by a computing device, feedstock of an agricultural biomass through a first supply chain;
tracking, by the computing device, residue of the agricultural biomass through a second supply chain; and
determining, by the computing device, a quantity of fuel, produced from the feedstock, having a carbon intensity value based on utilization of the residue in the second supply chain.

2. The method of claim 1 further comprising:
determining, by the computing device, a credit for utilization of the residue based on a quantity of the residue used and a type of use of the residue;
matching, by the computing device, the residue to the feedstock derived from the same agricultural biomass source;
applying, by the computing device, the credit to the fuel; and
determining, by the computing device, the quantity of fuel having the carbon intensity value.

3. The method of claim 1 wherein the second supply chain comprises a plurality of different types of uses for the residue; and further comprising:
determining, by the computing device, a plurality of credits for utilization of the residue, each credit based on a quantity of the residue used in one of the different types of uses and the different type of use of the residue;
for each use, matching, by the computing device, the residue to the feedstock derived from the same agricultural biomass source;
applying, by the computing device, the plurality of credits to the fuel; and
determining, by the computing device, the quantity of fuel having the carbon intensity value.

4. The method of claim 1 wherein the fuel is derived from multiple sources of agricultural biomass; and further comprising:
determining, by the computing device, a credit for utilization of the residue based on a quantity of the residue used and a type of use of the residue;
matching, by the computing device, the residue to the feedstock derived from the same agricultural biomass source;
applying, by the computing device, the credit to the fuel; and
determining, by the computing device, the quantity of fuel having the carbon intensity value.

5. The method of claim 1 wherein the feedstock is distributed to multiple fuel processing plants; and further comprising:
determining, by the computing device, a credit for utilization of the residue based on a quantity of the residue used and a type of use of the residue;
for each fuel processing plant, matching, by the computing device, the residue to the feedstock derived from the same agricultural biomass source;
applying, by the computing device, a fraction of the credit to the fuel produced by the fuel processing plant; and
determining, by the computing device, the quantity of fuel having the carbon intensity value.

6. The method of claim 1 further comprising using the carbon intensity value to qualify the fuel as compliant with a regulatory framework.

7. The method of claim 1 wherein tracking includes documenting, by the computing device, at least one of progress of the feedstock through the first supply chain or progress of the residue through the second supply chain.

8. The method of claim 1 further comprising compiling a report authenticating the carbon intensity value for the fuel, including obtaining and compiling documents authenticating quantities and sources for each step in each of the first supply chain and the second supply chain, and documenting chain of custody for the feedstock and the residue.

9. A method comprising:
creating, by a computing device, for biofuel feedstock, a feedstock entry in a database, the feedstock entry including feedstock information (i) characterizing biofuel derived from the biofuel feedstock and (ii) including a carbon intensity value for the biofuel;
creating, by the computing device, for feedstock residue, a residue entry in the database, the residue entry including residue information (i) characterizing the feedstock residue, (ii) including a cross-reference to the feedstock from which the feedstock residue is produced, and (iii) including a credit for utilization of the feedstock residue; and
utilizing, by the computing device, the cross-reference to apply the credit to the carbon intensity value of the biofuel to determine a revised carbon intensity value for the biofuel.

10. The method of claim 9 wherein the cross-reference is based on a geographic location where the agricultural biomass is produced.

11. The method of claim 9 wherein the cross-reference is based on a legal entity responsible for producing the agricultural biomass.

12. The method of claim 9 further comprising using the revised carbon intensity value to qualify the biofuel as compliant with a regulatory framework.

13. The method of claim 9 wherein the database includes a module for feedstock entries and a module for residue entries.

14. The method of claim 9 wherein the feedstock information includes an identifier for the biofuel feedstock and a quantity of the biofuel feedstock utilized to determine the cross-reference to the feedstock that is assigned to the feedstock residue.

15. The method of claim 9 wherein the residue information includes a quantity of the feedstock residue utilized to determine the credit for utilization of the feedstock residue.

16. The method of claim 9 further comprising:
generating a tradable credit from the revised carbon intensity value for the biofuel; and
trading, by the computing device, the biofuel having the tradable credit on an emission trading market.

17. The method of claim 9 further comprising using the computing device to track utilization of a plurality of residues derived from an agricultural biomass for each unit of the biofuel produced.

18. The method of claim 9 wherein the feedstock information and the residue information includes information about quantities and sources for each of the feedstock and the residue, and further comprising compiling a report authenticating the carbon intensity value for the fuel, including obtaining and compiling documents authenticating the quantities and sources for each of the feedstock and the residue, and documenting chain of custody for the feedstock and the residue.

19. A method comprising:
receiving, by a computing device, information about residue derived from agricultural biomass, the information including a source for the residue, a quantity of the residue, and a utilization of the residue;
creating, by the computing device, for the residue, a residue entry in a database, the residue entry including the residue information;
identifying, by the computing device, fuel produced from feedstock derived from the agricultural biomass;
updating, by the computing device, the residue entry in the database to include a cross-reference to the fuel.

20. The method of claim 19 further comprising:
using, by the computing device, the residue information to determine a credit for the residue;
applying, by the computing device, the credit to the fuel; and
determining, by the computing device, a carbon intensity value for the fuel.

21. The method of claim 19 further comprising, prior to determining the credit, receiving indicia of a trigger event related to delivery of the residue.

22. The method of claim 20 further comprising:
generating a tradable credit from the carbon intensity value for the fuel; and
trading, by the computing device, the fuel having the tradable credit on an emission trading market.

23. The method of claim 20 further comprising using the carbon intensity value to qualify the fuel as compliant with a regulatory framework.
